(19) United States
(12) Patent Application Publication
(10) Pub. No.: US 2023/0186622 A1
(43) Pub. Date: Jun. 15, 2023

(54) PROCESSING REMOTE SENSING DATA USING NEURAL NETWORKS BASED ON BIOLOGICAL CONNECTIVITY

(71) Applicant: X Development LLC, Mountain View, CA (US)

(72) Inventors: Sarah Ann Laszlo, Mountain View, CA (US); Lam Thanh Nguyen, Mountain View, CA (US); Baihan Lin, New York, NY (US)

(21) Appl. No.: 17/550,506

(22) Filed: Dec. 14, 2021

(51) Int. Cl. G06V 20/10; G06N 3/04; G06V 20/17; G06V 10/82; G06V 10/44; G06T 7/11; G06T 7/73; G06V 10/764

(52) U.S. Cl. CPC G06V 20/188; G06N 3/0454; G06V 20/17; G06V 10/82; G06V 10/44; G06T 7/11; G06T 7/73; G06V 10/764; G06T 2207/10032; G06T 2207/20084; G06T 2207/30188; G06T 2207/30244; G06T 2207/20221; G06T 2207/20081

(57) ABSTRACT

Methods, systems, and apparatus, including computer programs encoded on a computer storage medium, for processing remote sensing data using brain emulation neural networks. One of the methods includes obtaining an aerial image of a plurality of agricultural plots; processing the aerial image using an encoder subnetwork of a segmentation neural network to generate an encoder subnetwork output; processing the encoder subnetwork output using a brain emulation subnetwork of the segmentation neural network to generate a brain emulation subnetwork output; processing the brain emulation subnetwork output using a decoder subnetwork of the segmentation neural network to generate a network output that defines a segmentation of the aerial image into a plurality of categories including at least one agricultural plot category; and identifying at least one of the plurality of agricultural plots in the aerial image from the segmentation of the aerial image.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of computational units to generate an output for a received input. For example, a deep neural network is a deep machine learning model that includes an output layer and one or more hidden layers that each apply a non-linear transformation to a received input to generate an output.

### SUMMARY

This specification describes systems implemented as computer programs on one or more computers in one or more locations for processing remote sensing data using neural networks that include a brain emulation subnetwork whose parameters have been determined according to the biological connectivity between neuronal elements in the brain of a biological organism, e.g., a fly. The neural network is configured through training to process the remote sensing data, or a network input generated from the remote sensing data, and to generate a prediction about the remote sensing data. For example, the neural network can be configured to perform semantic segmentation of the remote sensing data.

This specification also describes systems for training a neural network that includes a brain emulation subnetwork to process the remote sensing data.

The remote sensing data can be any appropriate type of data that characterizes an environment. The remote sensing data can be captured by one or more sensors within or external to the environment. For example, the remote sensing data can include aerial images of the environment, e.g., images captured by satellites, planes, drones, and so on.

In some implementations, the parameters of a brain emulation subnetwork can be determined using a synaptic connectivity graph. A synaptic connectivity graph refers to a graph representing the structure of biological connections (e.g., synaptic connections or nerve fibers) between neuronal elements (e.g., neurons, portions of neurons, or groups of neurons) in the brain of a biological organism, e.g., a fly. For example, the synaptic connectivity graph can be generated by processing a synaptic resolution image of the brain of a biological organism.

For convenience, throughout this specification, an artificial neural network layer whose parameters have been determined using biological connectivity is called a “brain emulation” neural network layer. For convenience and to distinguish from brain emulation neural network layers, this specification refers to neural network layers whose parameters have not been determined using biological connectivity as “non-biological” neural network layers. The parameters of a non-biological neural network layer can be determined using supervised learning (e.g., backpropagation and gradient descent), unsupervised learning, or reinforcement learning, to name just a few examples. In some implementations, the parameters of a brain emulation neural network layer of a neural network are also updated during training of the neural network. That is, initial values for the parameters of the brain emulation neural network layer can be determined using biological connectivity, and those initial values can be updated using machine learning techniques.

In this specification, an artificial neural network having at least one brain emulation neural network layer is called a “brain emulation” neural network. Identifying an artificial neural network as a “brain emulation” neural network is intended only to conveniently distinguish such neural networks from other neural networks (e.g., with hand-engineered architectures), and should not be interpreted as limiting the nature of the operations that can be performed by the neural network or otherwise implicitly characterizing the neural network.

Similarly, in this specification, a subnetwork of an artificial neural network that includes at least one brain emulation neural network layer is called a “brain emulation” subnetwork, while other subnetworks of the neural network that do not include any brain emulation neural network layers are called “non-biological” subnetworks.

In this specification, the non-biological neural network layer immediately preceding a brain emulation subnetwork in the architecture of a neural network, and the non-biological neural network layer immediately following the brain emulation subnetwork in the architecture of the neural network, are called “connectivity” neural network layers. In some implementations, for each of one or more connectivity neural network layers of a neural network, the connectivity neural network layer divides the layer input to the connectivity neural network layer into multiple different channels, and processes each channel using one or more sub-layers of the connectivity neural network layer. Each sub-layer of a connectivity neural network layer can process a proper subset of the channels of the layer input to generate a respective channel of the layer output of the connectivity neural network layer. This process can significantly reduce the number of computations executed by the connectivity neural network layer compared to a fully-connected neural network layer.

In this specification, a “channel” of a first array of values is another array of values that includes a proper subset of the values of the first array. For example, if the first array is an N-dimensional array of values, then a channel of the first array can be an array that has at most N dimensions. In some implementations, a channel of an array includes a contiguous proper subset of the values of the array, i.e., each value in the channel is adjacent, within the array, to at least one other value in the channel.

Particular embodiments of the subject matter described in this specification can be implemented so as to realize one or more of the following advantages.

Using some techniques described in this specification, a system can process aerial images of agricultural plots using a brain emulation neural network to generate predictions about the plots. The system can use the generated predictions to make recommendations to a user (e.g., the owner of the agricultural plots) for optimizing the management of the agricultural plots. For example, the brain emulation neural network can be configured to predict an optimal watering schedule for the plots or an expected yield of the plots, which can help the user make decisions for maximizing the quality and/or quantity of crops produced on the plots.

Generally, the systems described in this specification can train and implement a neural network that includes a brain emulation subnetwork to process remote sensing data characterizing an environment to generate a prediction about the environment. As described in this specification, neural networks that include brain emulation subnetworks can achieve a higher performance (e.g., in terms of prediction accuracy), than other neural networks of an equivalent or greater size (e.g., in terms of number of parameters).

The efficiency gains of brain emulation neural networks when processing remote sensing data can be especially important for implementations in which the neural network is deployed in a resource-constrained environment, e.g., on a field device (e.g., aerial vehicle, e.g., aircraft or satellite) capturing remote sensing images. Generally, deploying a neural network that includes a brain emulation neural network directly onto a field device decreases the time required before receiving a network output from the neural network compared to executing the neural network on the cloud, as the device can execute all operations of the neural network locally and does not need to communicate with the cloud. For example, a field device can directly process remote sensing data using the neural network, even when the field device does not have access to network resources (e.g., if the field device is deployed in an environment that is outside of network connectivity).

Furthermore, by executing the operations of a brain emulation neural network on a field device, the privacy of the user of the field device (and, in some situations, the privacy of others in the environment represented by the remote sensing data) can be ensured. In particular, remote sensing data that has been captured by the field device and that may include private information of one or more people in the environment can be processed by the brain emulation neural network directly on the field device to generate a network output, as opposed to sending the remote sensing data to an external system, e.g., a cloud system, for processing. Thus, no personal information (e.g., audio or image data of the user or others in the environment) is exposed to an external system. That is, if the field device captures sensing data from an environment that includes one or more people, the privacy of the people in the environment can be protected by ensuring that the sensing data is only processed on the field device and not transferred to other devices from which the private data could be compromised.

As a particular example, if the remote sensing data includes aerial images of agricultural plots captured by a drone or plane, then the images can be directly processed on-board the drone or plane. For instance, the neural network can be configured to determine a semantic segmentation of the aerial images, and an external system can be configured to retrieve only the semantic segmentation from the drone or plane, and not the original aerial images. Thus, if the drone or plane captured any personal information in the aerial images, that information is not exposed. In some implementations, as described below, an on-board system of the drone or plane can use the semantic segmentation to crop the aerial images by removing a subset of the pixels (e.g., by removing pixels assigned a particular semantic class), ensuring that any private information depicted in the cropped portions of the images is not exposed.

In some implementations described in this specification, the brain emulation subnetwork of a neural network can have significantly fewer parameters than the non-biological subnetworks of the neural network. For example, a brain emulation neural network can include 100 or 1000 parameters, while the non-biological subnetworks of the neural network include hundreds of thousands or millions of parameters. Thus, inserting a brain emulation subnetwork into the architecture of a neural network can significantly improve the performance of the neural network while only negligibly increasing the number of computations or the amount of time required to execute the operations performed by the neural network. Therefore, using techniques described in this specification, a system can implement a highly efficient, low-latency, and low-power-consuming neural network.

The presence of a brain emulation subnetwork in the architecture of a neural network can further significantly reduce the amount of time required to train the neural network. That is, the amount of time required to train a neural network that includes a brain emulation subnetwork to achieve a particular performance can be significantly less than the time required to train another neural network that includes the same non-biological subnetworks but does not include a brain emulation subnetwork. For example, inserting a brain emulation subnetwork into the architecture of a neural network can reduce the amount of time required to achieve a particular performance by 100×, 1000×, or 10,000×.

As described above, in some implementations a connectivity neural network layer of a brain emulation neural network can divide its layer input into multiple different channels. Then, for each of multiple sub-layers of the connectivity neural network layer, the sub-layer can process a proper subset of the channels of the layer input to generate a respective channel of the layer output of the connectivity neural network layer. Such a connectivity neural network layer can be significantly more efficient, in terms of time, memory, and computations, than a fully-connected neural network layer would be at the same location in the architecture of the brain emulation neural network.

These efficiency gains can be especially important in low-resource or low-memory environments, e.g., on field devices or other edge devices. Additionally, these efficiency gains can be especially important in situations in which the brain emulation neural network is continuously processing network inputs, e.g., if the operations of the brain emulation neural network are executed by a field device that is deployed in the environment and that continuously processes remote sensing data that characterizes the environment and that has been captured by the field device.

The systems described in this specification can implement a brain emulation neural network having an architecture specified by a synaptic connectivity graph derived from a synaptic resolution image of the brain of a biological organism. The brains of biological organisms may be adapted by evolutionary pressures to be effective at solving certain tasks, e.g., classifying objects or generating robust object representations, and brain emulation neural networks can share this capacity to effectively solve tasks. In particular, compared to other neural networks, e.g., with manually specified neural network architectures, brain emulation neural networks can require less training data, fewer training iterations, or both, to effectively solve certain tasks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A illustrates an example field device that is configured to capture remote sensing data from an environment.

FIG. 1B illustrates an example neural network computing system.

FIG. 2 illustrates example remote sensing data and predictions generated from the remote sensing data by a brain emulation neural network.

FIG. 3 illustrates an example block of neural network layers that includes example connectivity neural network layers and an example brain emulation subnetwork.

FIG. 4 illustrates an example weight matrix of a brain emulation neural network layer determined using biological connectivity.

FIG. 5 illustrates an example neural network training system.

FIG. 6 illustrates an example of generating a brain emulation neural network based on a synaptic resolution image of the brain of a biological organism.

FIG. 7 shows an example data flow for generating a synaptic connectivity graph and a brain emulation neural network based on the brain of a biological organism.

FIG. 8 shows an example architecture mapping system.

FIG. 9 illustrates an example graph and an example sub-graph.

FIG. 10 is a flow diagram of an example process for processing remote sensing data using a brain emulation neural network.

FIG. 11 is a flow diagram of an example process for generating a brain emulation neural network.

FIG. 12 is a flow diagram of an example process for determining an artificial neural network architecture corresponding to a sub-graph of a synaptic connectivity graph.

FIG. 13 is a block diagram of an example architecture selection system.

FIG. 14 is a block diagram of an example computer system.

Like reference numbers and designations in the various drawings indicate like elements.

### DETAILED DESCRIPTION

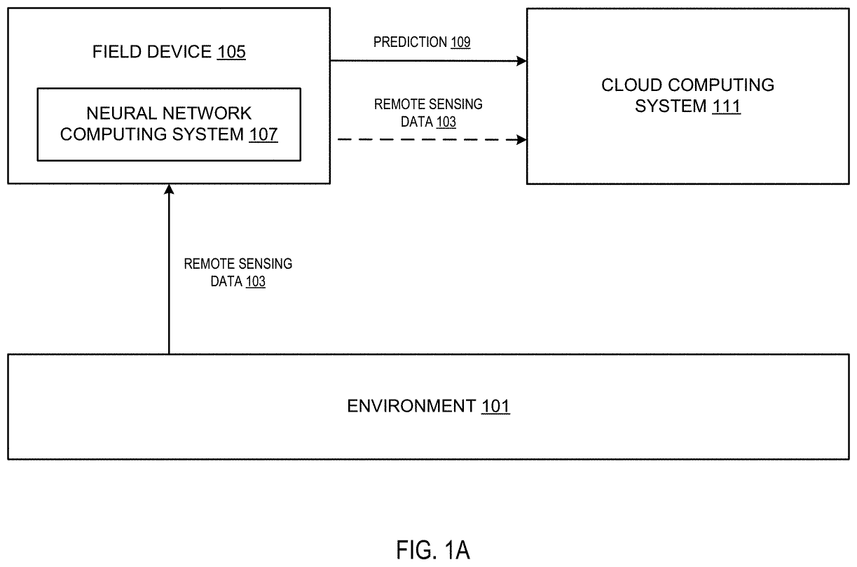

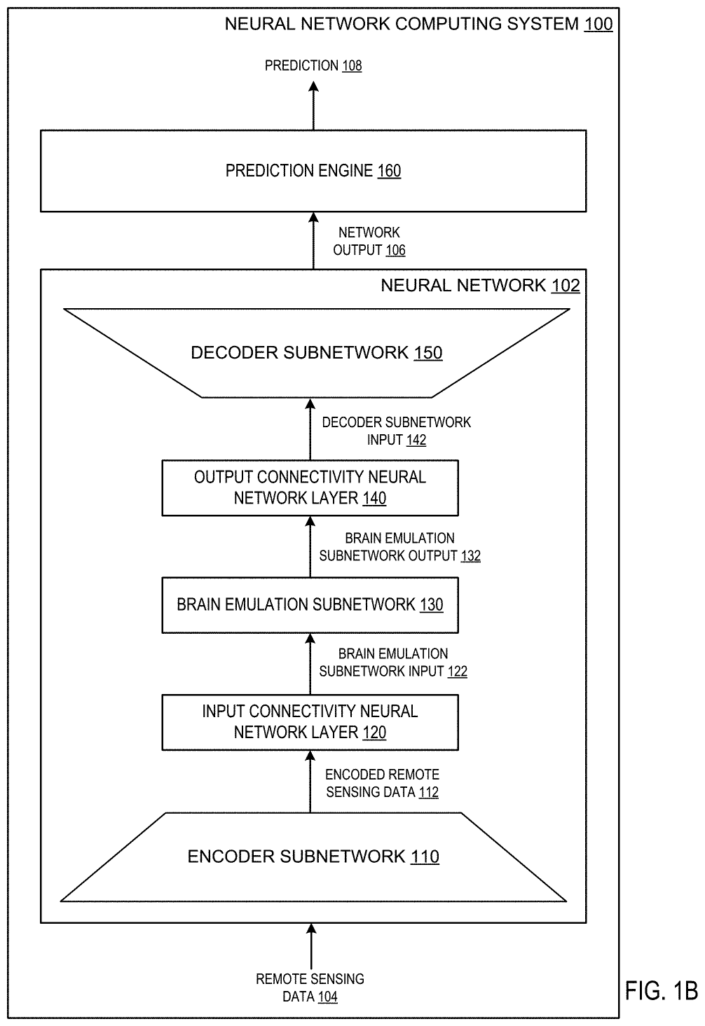

FIG. 1A illustrates an example field device 105 that is configured to capture remote sensing data 103 from an environment 101.

The field device 105 includes a neural network computing system 107 that is configured to process the remote sensing data 103 using a brain emulation neural network to generate a prediction 109 about the environment 101. The brain emulation neural network includes one or more brain emulation neural network layers whose parameters have been determined according to the biological connectivity between neuronal elements in the brain of a biological organism, e.g., synaptic connectivity between neurons in the brain of a biological organism. The brain emulation neural network has been configured through training to leverage structure of the biological connectivity (which has been, e.g., determined through evolutionary pressures on the species of the biological organism) to extract useful information from the remote sensing data 103 to generate the prediction 109. For example, the neural network computing system 107 can be the neural network computing system 100 described below with reference to FIG. 1B.

The environment 101 can be any appropriate environment from which remote sensing data 103 can be captured. For example, the environment 101 can include one or more agricultural plots, and the prediction 109 can represent a prediction about a state of the agricultural plots. As another example, the environment 101 can include a forested area, and the prediction 109 can represent a prediction about a state of the forested area. Example environments about which a neural network computing system can generate predictions are discussed in more detail below with reference to FIG. 1B.

The field device 105 can be any appropriate device that is configured to capture remote sensing data 103 from the environment 101. For example, the field device 105 can be on-board a vehicle that is operating within or outside the environment 101, e.g., an autonomous or semi-autonomous vehicle navigating through the environment 101, or a satellite, drone, or plane navigating above the environment 101.

After generating the prediction 109, the field device 105 can provide the prediction 109 to an external system, e.g., a cloud computing system 111, for storage, presentation to a user, or further processing. In some implementations, as described in more detail below with reference to FIG. 1B, the output of the neural network computing system 107 is post-processed to generate the prediction 109. In these implementations, the field device 105 can provide the raw output of the neural network computing system 107 to the cloud computing system 111, instead of or in addition to providing the prediction 109 itself.

In some implementations, the field device 105 only provides the prediction 109 to the cloud computing system 111 under certain conditions. That is, the field device 105 can be configured to continuously generate predictions 109 about the environment 101, and provide only some of the predictions 109 to the cloud computing system 111. For example, the field device 105 can provide only predictions 109 that satisfy one or more criteria to the cloud computing system 111, e.g., predictions that indicate an abnormality in the environment 101. As a particular example, if the prediction 109 represents a predicted current weather pattern in the environment 101, then the field device 105 can determine to send the prediction 109 to the cloud computing system 111 only if the prediction 109 identifies an extreme weather pattern (e.g., heavy snow, flooding, and so on), in order to alert a user of the cloud computing system 111.

In some implementations, the neural network computing system 107 is not a component of the field device 105, but rather is a component of the cloud computing system 111. For example, the field device 105 can be configured to continuously capture remote sensing data 103 from the environment 101 and provide the remote sensing data 103 to the cloud computing system 111. The cloud computing system 111 can then process the remote sensing data 103 using the neural network computing system 107 to generate the prediction 109 about the environment 111.

FIG. 1B shows an example neural network computing system 100. The neural network computing system 100 is an example of a system implemented as computer programs on one or more computers in one or more locations in which the systems, components, and techniques described below are implemented.

The neural network computing system 100 includes a neural network 102 and a prediction engine 160. The neural network 102 includes an encoder subnetwork 110, an input connectivity neural network layer 120, a brain emulation subnetwork 130, an output connectivity neural network layer 140, and a decoder subnetwork 150.

The neural network system 100 is configured to process remote sensing data 104 that characterizes an environment and to generate a prediction 108 about the environment. The remote sensing data 104 can be captured by one or more sensors within or external to the environment. For example, the remote sensing data 104 can include sensor data captured from above the environment, e.g., captured by satellites, planes, or drones operating above the environment.

As a particular example, the remote sensing data 104 can include aerial images of the environment. The aerial images can characterize any appropriate range of electromagnetic frequencies. For instance, the remote sensing data 104 can include one or more visible-light images of the environment, e.g., RGB images. Instead or in addition, the remote sensing data 104 can include one or more infrared images, one or more radar images, one or more x-ray images, one or more ultrasound images, one or more ultraviolet images, one or more multispectral images, and/or one or more hyperspectral images of the environment. As another particular example, the remote sensing data 104 can include one or more LIDAR images of the environment, e.g., LIDAR images that each include multiple points that are each associated with a three-dimensional location in the environment and, optionally, one or more other parameters (e.g., an intensity parameter).

The neural network system 100 can be configured to process the remote sensing data 104 to perform any appropriate machine learning task. That is, the prediction 108 generated from the remote sensing data 104 can be any appropriate prediction about the environment, e.g., any kind of score, classification, or regression output based on the remote sensing data 104. For example, the prediction 108 can represent a predicted semantic segmentation of the remote sensing data 104. For instance, in implementations in which the remote sensing data 104 includes an image of the environment, the prediction 108 can identify, for each pixel in the image, a predicted semantic class that is represented by the pixel.

As a particular example, the environment can include one or more agricultural plots, and the remote sensing data 104 can include one or more aerial images of the agricultural plots. The neural network system 100 can be configured to process the aerial images and to generate a prediction 108 that characterizes the agricultural plots. For example, the prediction 108 can identify, for each pixel of the aerial images, whether or not the pixel represents an agricultural plot; that is, the prediction 108 can be a binary semantic segmentation of the aerial images. As another example, the prediction 108 can identify, for each pixel of the aerial images, a type of agricultural plot that the pixel represents (e.g., a type of crop grown in the agricultural plot); that is, the prediction 108 can be a multi-class semantic segmentation of the aerial images. In this specification, an agricultural plot is an area of land on which one or more crops are currently being grown, or on which crops have been grown in the past or will be grown in the future (e.g., in the case where an agricultural plot is currently lying fallow).

As another example, the prediction 108 can delineate the boundaries between the agricultural plots. For instance, the prediction 108 can identify multiple pixels in an aerial image of the agricultural plots that represent boundaries between respective agricultural plots. Instead or in addition, for each boundary between respective agricultural plots, the prediction 108 can define a one-dimensional curve within the aerial image that represents the boundary. Instead or in addition, the prediction 108 can define the real-world geometry of the boundaries between agricultural plots, e.g., by identifying, for each boundary between respective agricultural plots, real-world coordinates of the boundary.

As another example, the prediction 108 can represent a prediction for how the agricultural plots will progress in the future. For instance, the prediction 108 can predict a crop yield for each agricultural plot. Instead or in addition, the prediction 108 can predict a future time point at which each agricultural plot should be harvested.

As another example, the prediction 108 can characterize a predicted current state of the agricultural plots, e.g., a current health of the agricultural plots. For instance, the prediction 108 can predict the degree to which the agricultural plots are affected by one or more of: pests, dehydration, element insufficiency, sunburn, and so on.

As another example, the prediction 108 can represent a recommended action to be taken with respect to the agricultural plots, e.g., a recommended action for optimizing the yields of the agricultural plots. For instance, the prediction 108 can identify, for each agricultural plot, a recommended amount of water to be applied to the agricultural plot. Instead or in addition, the prediction 108 can identify, for each agricultural plot, a recommended amount of fertilizer to be applied to the agricultural plot. As a particular example, the prediction 108 can identify one or more recommended actions to be taken based on a prediction of the current health of the agricultural plots, as described above. In some implementations, the prediction 108 can identify a different recommended action for each of multiple portions of the agricultural plots, e.g., recommending a particular action to be taken on a portion of one of the agricultural plots in response to identifying that the portion of the agricultural plot has been affected by element insufficiency.

As another example, the prediction 108 can represent an instance segmentation of the agricultural plots, where the prediction 108 identifies, for each particular agricultural plot depicted in the aerial images of the remote sensing data 104, one or more pixels of the aerial images depicting the particular agricultural plot.

As another particular example, the environment can include an airport, and the remote sensing data 104 can include one or more aerial images of the airport. The neural network system 100 can be configured to process the aerial images and to generate a prediction 108 that characterizes the airport. For instance, the prediction 108 can identify, for each pixel of the aerial images, a type of structure that the pixel represents; that is, the prediction 108 can be a multi-class semantic segmentation, where the set classes can include one or more of: one or more “building” classes corresponding to respective different types of buildings of the airport, one or more “road” classes corresponding to respective different types of roads of the airport, or a runway class corresponding to the runways of the airport.

As another particular example, the environment can include a forest, and the remote sensing data 104 can include one or more aerial images of the forest. The neural network system 100 can be configured to process the aerial images and to generate a prediction 108 that characterizes the forest. For instance, the prediction 108 can identify, for each pixel of the aerial images, whether the pixel represents a forested area or a deforested area. Instead or in addition, the prediction 108 can delineate the boundaries of the forest. Instead or in addition, the prediction 108 can identify one or more roads or paths within the forest. Instead or in addition, the prediction 108 can represent a prediction of the stability of the local ecosystem of the environment, e.g., by identifying an effect of an invasive species on the forest or a portion of the forest. Instead or in addition, the prediction 108 can represent a recommended action to be taken with respect to the forest, e.g., a recommendation for assigning a forest ranger to the forest or scheduling visits by the forest ranger.

As another particular example, the environment can include one or more streets of a city, and the remote sensing data 104 can include images of features of the streets, e.g., aerial images captured from above the city or images captured by a vehicle navigating the streets of the city. The neural network system 100 can be configured to process the images and to generate a prediction 108 that characterizes the features of the streets. For instance, the prediction 108 can identify one or more street signs, traffic lights, pedestrians, other vehicles, and/or buildings depicted in the images.

The neural network 102 is configured to process the remote sensing data 104 and to generate a network output 106 that characterizes the remote sensing data 104. The prediction engine 160 is configured to process the network output 106 and to generate the prediction 108.

In some implementations, the neural network system 100 first generates a network input from the remote sensing data 104, and the neural network 102 then processes the network input to generate the network output 106. For example, the neural network system 100 can pre-process the remote sensing data 104 to generate the network input, e.g., by applying one or more denoising techniques or orthorectification techniques to the sensing data 104. Orthorectification is a process of processing an image to remove the effects of the perspective (e.g., the tilt) from which the image was captured. Orthorectification is discussed in more detail below.

Instead or in addition to pre-processing the remote sensing data 104, the neural network system 100 can generate the network input by adding one or more other elements to the network input in addition to the remote sensing data. The one or more additional elements can include any data that characterizes the environment. For example, the additional elements can identify a time at which the remote sensing data 104 was captured, e.g., the time of day at which the remote sensing data 104 was captured or the date on which the remote sensing data 104 was captured. As another example, the additional elements can identify the location of the environment in the real world, e.g., by identifying the latitude and longitude of the environment.

As another particular example, the additional elements can identify one or more classes, from a set of multiple classes, to which the environment belongs. As a particular example, if the remote sensing data 104 characterizes a forest, the network input can identify a particular type of the forest, e.g., a temperate, tropical, or boreal forest. As another particular example, if the remote sensing data 104 characterizes one or more agricultural plots, the network input can identify one or more crop types that are known to be grown on the agricultural plots (that is, in implementations in which the neural network system 100 is not itself configured to predict the types of crops grown on the agricultural plots).

Although the below description generally refers to processing remote sensing data directly, it is to be understood that a neural network can be configured to process any appropriate network input generated from the remote sensing data.

The encoder subnetwork 110 of the neural network 102 is configured to process the remote sensing data 104 and to encode the remote sensing data 104, generating encoded remote sensing data 112. The encoded remote sensing data 112 is an embedding of the remote sensing data 104.

In this specification, an encoder subnetwork of a neural network is a subnetwork that includes one or more non-biological neural network layers and that, in some implementations, reduces the size of one or more dimensions of the network input to the neural network (or, in some implementations, reduces the size of one or more dimensions of a hidden representation of the network input). That is, an encoder subnetwork is configured to process an encoder subnetwork input (generated from, or equal to, the network input to the neural network) and to generate an encoder subnetwork output, where in some implementations, the encoder subnetwork output has a smaller size than the encoder subnetwork input (e.g., as measured by the respective resolutions of the encoder subnetwork input and the encoder subnetwork output). Thus, in the example depicted in FIG. 1B, the encoded remote sensing data 112 has a smaller size than the remote sensing data 104. In some other implementations, the encoder subnetwork 110 can maintain the resolution of the remote sensing data 104 when generating the encoded remote sensing data 112. In some other implementations, the encoder subnetwork 110 can increase the size of one or more dimensions of the remote sensing data 104. For example, if the remote sensing data 104 includes an image with c₁ channels (e.g., an RGB image where c₁=3), then the encoded remote sensing data 112 can include an encoded image with c₂ channels, where c₁<c₂. As a particular example, if the remote sensing data 104 includes an m₁×n₁×c₁ image, then the encoded remote sensing data 112 can include an m₂×n₂×c₂ encoded image, where m₁>m₂, n₁>n₂, and c₁<c₂.

The encoder subnetwork 110 can include any appropriate type of non-biological neural network layers, e.g., one or more convolutional neural network layers, one or more recurrent neural network layers, one or more feedforward neural network layers, and/or one or more self-attention neural network layers. Example architectures for the neural network 102 are discussed in more detail below.

In some implementations, in addition to one or more non-biological neural network layers, the encoder subnetwork 110 also includes one or more brain emulation neural network layers. In some other implementations, the encoder subnetwork 110 is a non-biological subnetwork, i.e., does not include any brain emulation neural network layers.

The input connectivity neural network layer 120 is a non-biological neural network layer directly preceding the brain emulation subnetwork 130 of the neural network 102. The input connectivity neural network layer 120 is configured to process the encoded remote sensing data 112 and to generate a brain emulation subnetwork input 122 for the brain emulation subnetwork 130.

The brain emulation subnetwork input 122 can have a predefined dimensionality, e.g., a dimensionality required by the brain emulation neural network architecture of the brain emulation subnetwork 130 determined using biological connectivity. The input connectivity neural network layer 120 can be configured to project the encoded remote sensing data 112 to the predefined dimensionality of the brain emulation subnetwork input 122. That is, the input connectivity neural network layer 120 can be configured to map the output of the encoder subnetwork 110 to the required dimensionality for processing by the brain emulation subnetwork 130.

After the neural network 102 has been trained, the input connectivity neural network layer 120 is configured to generate a brain emulation subnetwork input 122 that is optimized for the brain emulation subnetwork 130, e.g., that encodes maximal information from the remote sensing data 104 that is usable by the brain emulation subnetwork 130. That is, the input connectivity neural network layer 120 can be configured through training (e.g., training that includes processing multiple different sets of remote sensing data 104) to encode, into the brain emulation subnetwork input 122 for eventual processing by the brain emulation subnetwork 130, the information from the remote sensing data 104 that is useful for generating the prediction 108 about the environment characterized by the remote sensing data 104.

In some implementations, the input connectivity neural network layer 120 is a fully-connected neural network layer. That is, each element of the encoded remote sensing data 112 can be used to generate each element of the brain emulation subnetwork input 122.

In some other implementations, the input connectivity neural network layer 120 divides the encoded remote sensing data 112 into multiple channels, and generates respective channels of the brain emulation subnetwork input 122 by processing respective proper subsets of the channels of the encoded remote sensing data 112. That is, each element of the brain emulation subnetwork input 112 can be generated from a proper subset of the elements of the encoded remote sensing data 112. Typically, such a connectivity neural network layer has fewer trained parameters than a fully-connected neural network, thus requiring less time to train and execute at inference.

In other words, the output of a connectivity neural network layer (e.g., the brain emulation subnetwork input 122 generated by the input connectivity neural network layer 120) can include multiple different components, and the connectivity neural network layer can generate each component by processing only a respective proper subset of the input to the connectivity neural network layer (e.g., the encoded remote sensing data 112).

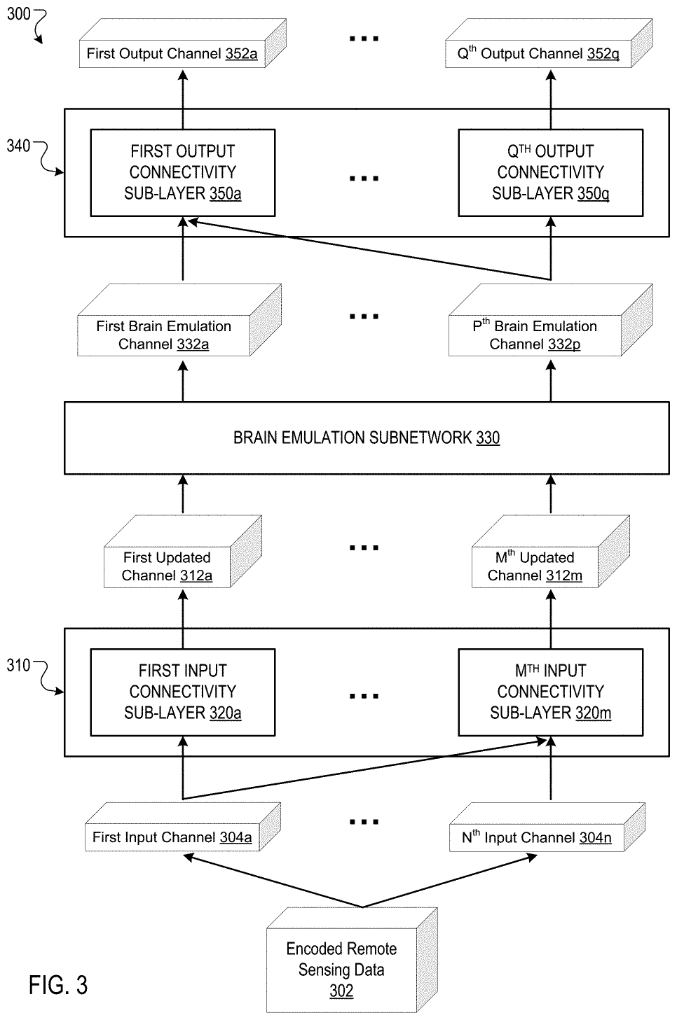

Example connectivity neural network layers for processing hidden representations of remote sensing data are described in more detail below with reference to FIG. 3.

The brain emulation subnetwork 130 is configured to process the brain emulation subnetwork input 122 and to generate a brain emulation subnetwork output 132, which can be processed by subsequent neural network layers in the neural network 102. The brain emulation subnetwork input 122 and the brain emulation subnetwork output 132 may be represented in any appropriate numerical format, for example, as vectors or as matrices.

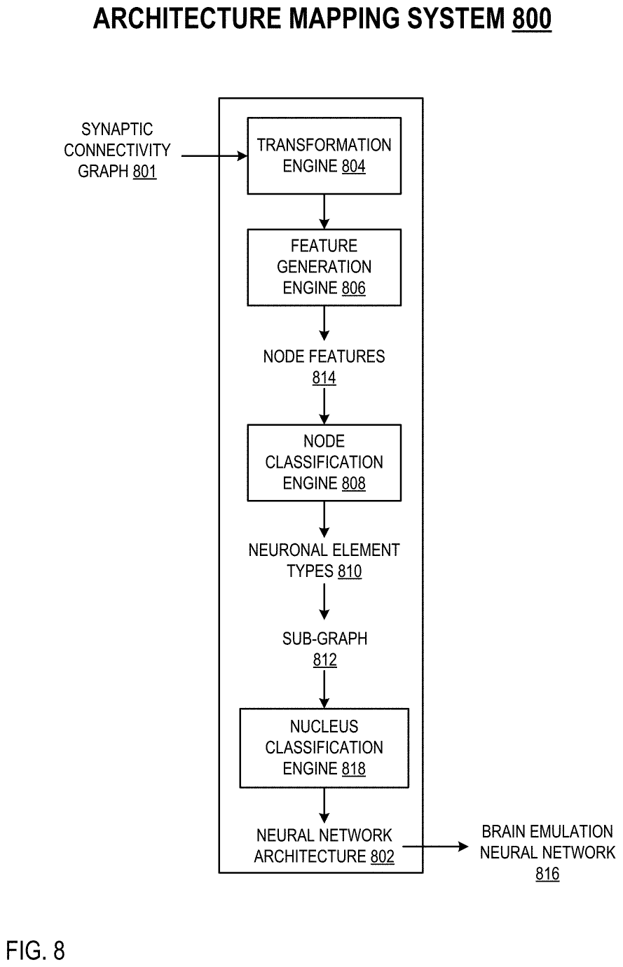

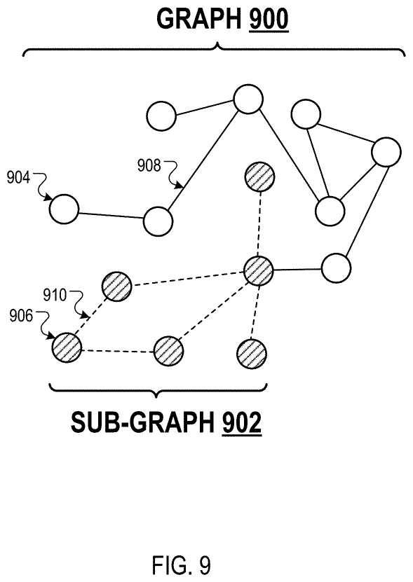

The brain emulation subnetwork 130 can have an architecture that is based on a synaptic connectivity graph representing biological connectivity between neuronal elements in the brain of the biological organism, e.g., synaptic connectivity between neurons in the brain of a biological organism. An example process for determining a network architecture using a synaptic connectivity graph is described below with respect to FIG. 8. In some implementations, the architecture of the brain emulation subnetwork 130 can be specified by the biological connectivity between neuronal elements of a particular type in the brain, e.g., neuronal elements that process sensory inputs that are of the same type (or that are otherwise similar to) the remote sensing data that the neural network is configured to process, e.g., neuronal elements from the visual system. This process is described in more detail below with reference to FIG. 8 and FIG. 9.

The output connectivity neural network layer 140 is a non-biological neural network layer directly following the brain emulation subnetwork 130 of the neural network 102. The output connectivity neural network layer 140 is configured to process the brain emulation subnetwork output 132 and to generate a decoder subnetwork input 142 for the decoder subnetwork 150. After the neural network 102 has been trained, the output connectivity neural network layer 140 is configured to generate a decoder subnetwork input 142 that is optimized for the decoder subnetwork 150, e.g., that encodes maximal information from the brain emulation subnetwork output 132 (and originally from the remote sensing data 104) that is usable by the decoder subnetwork 150.

The brain emulation subnetwork 130 can be configured to generate a brain emulation subnetwork output 132 that has a predefined dimensionality, e.g., a dimensionality required by the brain emulation neural network architecture of the brain emulation subnetwork 130 determined using biological connectivity. The output connectivity neural network layer 140 can be configured to project the brain emulation subnetwork output 132 from the predefined dimensionality of the brain emulation subnetwork output 132 to a dimensionality that is required by the decoder subnetwork 150. That is, the output connectivity neural network layer 140 can be configured to map the output of the brain emulation subnetwork 130 to the required dimensionality for processing by the decoder subnetwork 150.

In some implementations, the output connectivity neural network layer 140 is a fully-connected neural network layer. In some other implementations, the output connectivity neural network layer 140 divides the brain emulation subnetwork output 132 into multiple channels, and generates respective channels of the decoder subnetwork input 142 by processing respective proper subsets of the channels of the brain emulation subnetwork output 132. Generally, the input connectivity neural network layer 120 and the output connectivity neural network layer 140 can be the same type of neural network layer (e.g., both fully-connected neural network layers) or different types of neural network layer.

The decoder subnetwork 150 of the neural network 102 is configured to process the decoder subnetwork input 142 to generate the network output 106.

In this specification, a decoder subnetwork of a neural network is a subnetwork that includes one or more non-biological neural network layers and that, in some implementations, increases the size of one or more dimensions of a hidden representation of the network input to the neural network. That is, a decoder subnetwork is configured to process a decoder subnetwork input (generated from the network input to the neural network) and to generate a decoder subnetwork output, where in some implementations, the decoder subnetwork output has a larger size (e.g., as measured by the resolution of the decoder subnetwork output) than the decoder subnetwork input. Thus, in the example depicted in FIG. 1B, the network output 106 has a larger size than the decoder subnetwork output 142. In some other implementations, the decoder subnetwork 150 can maintain the resolution of the decoder subnetwork input 142 when generating the network output 106. In some other implementations, the decoder subnetwork 150 can decrease the size of one or more dimensions of the decoder subnetwork input 142.

The decoder subnetwork 150 can include any appropriate type of non-biological neural network layers, e.g., one or more convolutional neural network layers, one or more recurrent neural network layers, one or more feedforward neural network layers, and/or one or more self-attention neural network layers.

In some implementations, in addition to one or more non-biological neural network layers, the decoder subnetwork 150 also includes one or more brain emulation neural network layers. In some other implementations, the decoder subnetwork 150 is a non-biological subnetwork, i.e., does not include any brain emulation neural network layers.

In some implementations, the brain emulation subnetwork input 122 is at a “bottleneck” of the neural network 102. In this specification, a bottleneck of a neural network is a location in the architecture of the neural network at which the hidden representation of the network input to the neural network is smallest. That is, the brain emulation subnetwork input 122 (or the brain emulation subnetwork output 132, in some implementations in which the brain emulation subnetwork 130 itself changes the size of the hidden representation) can be the smallest hidden representation of the remote sensing data 104, of all hidden representations of the remote sensing data 104 generated by respective neural network layers of the neural network 102.

The neural network 102 can have any appropriate network architecture.

For example, the neural network 102 can be a convolutional neural network that includes one or more convolutional neural network layers. In implementations in which the remote sensing data 104 includes one or more images of the environment, the convolutional neural network layers of the neural network 102 can apply learned convolutional kernels to the images in the remote sensing data 104 (or to hidden representations of the images) to generate the network output 106. As a particular example, the encoder subnetwork 110 can process the remote sensing data 104 using a sequence of dimension-reducing convolutional neural network layers to generate the encoded remote sensing data 112, and the decoder subnetwork 150 can process the decoder subnetwork input 142 using a sequence of dimension-increasing convolutional neural network layers to generate the network output 106.

Instead or in addition to non-biological convolutional neural network layers, the brain emulation subnetwork 130 can include one or more convolutional neural network layers whose respective convolutional kernels have been generated using the biological connectivity between neuronal elements in the brain of the biological organism. As a particular example, the elements of the convolutional kernel of a convolutional neural network layer in the brain emulation subnetwork 130 can be the same as a subset of the elements of a synaptic connectivity graph; e.g., the elements of the convolutional kernel can be the elements in a particular row or column of the synaptic connectivity graph. Generating convolutional kernels using biological connectivity is discussed in more detail in U.S. patent application Ser. No. 17/236,647, which is herein incorporated by reference in its entirety.

As another example, the neural network 102 can be an autoencoder neural network, where the encoder subnetwork 110 is the encoder of the autoencoder and the decoder subnetwork 150 is the decoder of the autoencoder. That is, the neural network 102 can be an autoencoder neural network that is configured to generate an embedding of the remote sensing data 104 (e.g., using the encoder subnetwork 110, where the embedding is the encoded remote sensing data 112) and then process the embedding to reconstruct the remote sensing data 104 (e.g., using the decoder subnetwork 150, where the network output 106 is a predicted reconstruction of the remote sensing data 104). As a particular example, the neural network 102 can be a variational autoencoder that models the latent space of the generated embeddings using a mixture of distributions instead of a fixed vector.

For example, to train the autoencoder neural network, a training system can evaluate an objective function that measures an error between: (i) the remote sensing data 104, and (ii) the predicted reconstruction 106 of the remote sensing data 104. The training system can then update at least some of the neural network parameters of the neural network 102 using respective gradients of the objective function.

Autoencoder neural networks can be used for many different machine learning tasks. For example, after training, the encoder subnetwork of an autoencoder neural network can be used to generate compact embeddings of the remote sensing data 104. Because the encoder subnetwork 110 has been trained to generate encoded remote sensing data 112 that can be used by the decoder subnetwork 150 to reconstruct the remote sensing data 104, the encoder subnetwork 110 can be configured to incorporate a maximal amount of information about the remote sensing data 104 into the encoded remote sensing data 112, making the encoded remote sensing data 112 a rich representation of the information in the network input 104. These embeddings 112 can be used by downstream systems to perform further machine learning tasks. In some implementations, the same encoded remote sensing data 112 can be used by multiple different downstream systems to perform multiple different respective machine learning tasks.

As another example, the neural network computing system 100 can be configured to perform anomaly detection using the autoencoder neural network 102. Based on a difference between the remote sensing data 104 and the predicted reconstruction 106 of the remote sensing data 104, the neural network computing system 100 can generate a prediction 108 of whether there are one or more anomalies in the remote sensing data 104, indicating a possible anomaly in the environment. Because the neural network 102 can been configured through training to generate network outputs 106 that closely resemble the remote sensing data 104, if the neural network system 100 determines that the difference between (i) a particular network output 106 generated from a particular set of remote sensing data 104 and (ii) the particular set of remote sensing data 104 is larger than normal, the neural network system 100 can determine that the particular set of remote sensing data 104 is atypical in some way.

As a particular example, in implementations in which the remote sensing data 104 includes aerial images of agricultural plots, the neural network system 100 can be configured to determine whether the depiction of the agricultural plots is anomalous, e.g., because the crops grown on the agricultural plots are not progressing as expected or because a foreign plant has encroached on the agricultural plots. As another particular example, in implementations in which the remote sensing data 104 includes aerial images of a forested area, the neural network system 100 can be configured to determine whether the depiction of the forested area is anomalous, e.g., because of unexpected deforestation.

The prediction engine 160 is configured to process the network output 106 to generate the prediction 108 about the environment represented in the remote sensing data 104.

For example, the neural network system 100 can be configured to determine a semantic segmentation of the remote sensing data 104 (e.g., a semantic segmentation of an image in the remote sensing data 104). In these implementations, for each element of the remote sensing data 104 (e.g., for each pixel of an image in the remote sensing data 104) and for each of multiple classes to which the element can be assigned, the network output 106 can include a respective score (e.g., a value between 0 and 1) that represents a likelihood that the element belongs to the class. The prediction engine 160 can then determine, for each element in the remote sensing data 104, a final prediction of one or more classes to which the element belongs. For example, the prediction engine 160 can assign each element to the class that has the highest score corresponding to the element in the network output 106. As another example, the prediction engine can assign each element to a class if the score for the class corresponding to the element in the network output 106 exceeds a predetermined threshold.

As another example, the neural network system 100 can be configured to determine a boundary between respective regions in the environment represented by the remote sensing data 104, e.g., a boundary between respective agricultural plots in the environment or a boundary between a forested area and a deforested area in the environment. In these implementations, the network output 106 can include a semantic segmentation of the remote sensing data 104 as described above, and the prediction engine 160 can determine the boundary using the semantic segmentation. For example, the prediction engine 160 can determine sets of contiguous pixels (or other elements of the remote sensing data 104) that have been assigned the same semantic class, and determine the boundaries between the sets of contiguous pixels. As a particular example, the prediction engine 160 can generate a prediction 108 that identifies a set of “boundary pixels” at the boundaries between the sets of contiguous pixels. Instead or in addition, the prediction engine 160 can generate a one-dimensional curve from the boundary pixels, e.g., by executing a polynomial curve fitting procedure for fitting a polynomial curve (e.g., a linear, quadratic, or cubic curve) over the pixels.

In some such implementations, the prediction engine 160 can determine, from the determined boundaries of the remote sensing data 104 (e.g., boundaries between pixels in an image of the remote sensing data 104), corresponding real-world boundaries between regions of the environment. That is, if the determined boundaries are represented in a coordinate system defined by the remote sensing data 104 (e.g., if the determined boundaries are represented by boundary pixels having pixel coordinates within an image of the remote sensing data 104), the prediction engine 160 can process the determined boundaries to translate the determined boundaries into real-world coordinates. For example, the prediction engine 160 can obtain data identifying a location and pose, in the real world, of the sensors that captured the remote sensing data 104. The prediction engine 160 can then use the location and pose of the sensors to translate the determined boundaries, in the coordinate system defined by the remote sensing data 104, into real-world coordinates.

As another example, in implementations in which the network output 106 is a reconstructed version of the remote sensing data 104, the prediction engine 160 can determine a difference between the network output 106 and the remote sensing data 104 in order to determine whether the remote sensing data 104 is anomalous, as described above.

In some implementations, the prediction 108 is the same as the network output 106. That is, the neural network 102 can be configured to directly generate the prediction 108 without requiring further processing by a prediction engine 160.

In some implementations, the neural network computing system 100 is configured to process multiple different sets of remote sensing data 104 that each represent the same environment using the neural network 102 to generate respective network outputs 106. The prediction engine 106 can then combine the respective network output 106 for each set of remote sensing data 104 to generate a final prediction 108 about the environment.

For example, each set of remote sensing data 104 can represent a different portion of the environment. The prediction engine 160 can generate a respective initial prediction corresponding to each portion of the environment using the respective network output 106 generated from the set of remote sensing data 104 that represents the portion of the environment. The prediction engine 160 can then “stitch” the respective initial predictions together to generate the final prediction 108 that represents all portions of the environment. For instance, if the respective remote sensing data 104 representing each portion of the environment includes an image depicting the portion of the environment, then the prediction engine 160 can determine a schema for stitching together the aerial images to generate a combined image that depicts all locations in the environment, where the relative positioning of the original aerial images within the combined image characterizes the real-world spatial relationship between the portions of the environment depicted in the original aerial images (that is, the positioning of the pixels of the combined image maintains the spatial relationship between the locations in the environment represented by the pixels). In particular, the prediction engine 160 can determine the schema using data identifying, for each aerial image, a location and pose of the camera that captured the aerial image at the time that the aerial image was captured. The prediction engine 160 can then combine the respective initial predictions using the same schema to generate the final prediction 108 about the environment.

As a particular example, each initial prediction can itself be represented by an image of the corresponding portion of the environment, e.g., an image where each pixel, representing a respective location in the portion of the environment, has a value identifying the semantic class to which the location of the portion environment has been assigned. The prediction engine 160 can then use the determined schema to stitch together the initial images to generate a final image that includes a respective prediction about all portions of the environment.

After generating the prediction 108 about the remote sensing data 104, the neural network computing system 100 can provide the prediction 108 to one or more downstream systems, e.g., for storage, further processing, or presentation to a user.

In some implementations, the neural network computing system 100 provides the prediction 108 (or the network output 106) to one or more downstream machine learning models, and the downstream machine learning models can use the prediction 108 to further process the remote sensing data 104 and make additional predictions about the remote sensing data 104. The downstream machine learning model can be configured to perform any appropriate machine learning task using the remote sensing data 104, e.g., one or more of the machine learning tasks described above with reference to the neural network computing system 100.

For example, if the prediction 108 represents a semantic segmentation of the elements of the remote sensing data 104, then a downstream machine learning model can determine only to process a subset of the remote sensing data 104 according to the semantic segmentation; e.g., the downstream machine learning model can determine only to process elements of the remote sensing data 104 belonging to one or more particular semantic classes. In some implementations, the neural network computing system 100 provides the entire set of remote sensing data 104 to the downstream machine learning model, and the downstream machine learning model determines which subset of the remote sensing data 104 to process. In some other implementations, the neural network computing system 100 provides only the required subset of the remote sensing data 104 to the downstream machine learning model. For instance, if the prediction 108 includes a semantic segmentation of the pixels of an image in the remote sensing data 104, then the neural network computing system 100 can crop the image to only include the pixels belonging to one or more particular semantic classes (i.e., removing all pixels that belong to any other semantic class), and provide the cropped image to the downstream neural network.

As a particular example, if the environment includes one or more agricultural plots and the prediction 108 segments the elements of the remote sensing data 104 into (i) a first set of elements that represent respective agricultural plots and (ii) a second set of elements that do not represent any agricultural plot, then the downstream machine learning model can process only the first set of elements. The downstream machine learning model can be configured to generate a prediction about the agricultural plots (e.g., a predicted crop yield or a recommended watering policy); thus, ignoring elements of the remote sensing data 104 that do not represent any agricultural plot can improve the efficiency of the downstream machine learning model, e.g., by reducing the amount of time and computational resources required to process the remote sensing data 104.

As another particular example, if the environment includes one or more agricultural plots and the prediction 108 segments the elements of the remote sensing data 104 into a set of semantic classes that includes multiple classes corresponding to respective different crop types (e.g., corn, rice, wheat, and so on), then the downstream machine learning model can process only elements corresponding to a particular crop type. The downstream machine learning model can be configured to generate predictions about agricultural plots corresponding only to the particular crop type (e.g., a predicted crop yield or a recommended watering policy), and thus can be configured to process only elements of the remote sensing data 104 that represent the particular crop type. For instance, a downstream system can include multiple different downstream machine learning models that are each configured to generate predictions for different respective crop types.

In some implementations, the operations of the neural network computing system 100 are executed on a single device, e.g., a parallel processing device such as a graphics processing unit (GPU) or tensor processing unit (TPU). In some such implementations, the neural network 102 can be configured to execute in a resource-constrained environment, e.g., an edge device such as a mobile phone, tablet, laptop, drone, scientific computing device, and so on. In these implementations, the neural network computing system 100 can be trained to perform at a high level (e.g., in terms of prediction accuracy) even with very few model parameters compared to other neural networks.

The inclusion of the brain emulation subnetwork 130 in the architecture of the neural network 102 can provide this high efficiency; because the parameters and architecture of the brain emulation subnetwork 130 have been determined using biological connectivity, as described in more detail below, the subnetwork 130 is configured to extract maximal information from the brain emulation subnetwork input 122 with relatively few operations. For example, while some existing techniques require the training and execution of neural networks that include millions or billions of parameters in order to achieve high performance, the neural network 102 can include, e.g., merely hundreds, thousands, or hundreds of thousands of parameters and still achieve high performance.

As a particular example, the neural network computing system 100 can be deployed on a scientific field device that is configured to capture the remote sensing data 104 and process the remote sensing data 104 to generate the prediction 108 about the environment in which the scientific field device is operating. The scientific field device can have access to relatively few computational and memory resources, and can be deployed in environments that do not provide access to a power source, thus requiring the device to execute the operations of the neural network computing system 100 without significantly draining the battery of the device.

Furthermore, the ability of the device to execute the operations of the neural network computing system 100 locally on the device can be especially important for use cases where the device does not have network access, e.g., Internet access, in the field. Thus, a user is not required to capture the remote sensing data 104 in the field and then return from the field to a location that has network access in order to upload the remote sensing data 104 to an external system that executes the neural network computing system 100; rather, the user can process the remote sensing data 104 in the field directly on the device, allowing the user to review the corresponding prediction 108 and receive immediate feedback.

As another particular example, the neural network computing system 100 can be deployed on a long-term device that is installed in a location and, over the course of multiple days, months, or years, continuously captures data and processes the data using the neural network computing system 100. For example, the device can be configured to monitor the ambient environment in the location, e.g., a warehouse or other facility, and to and notify a user if an issue is detected.

As another particular example, the neural network computing system 100 can be deployed on an autonomous or semi-autonomous vehicle or drone. The smaller model size, and/or increased efficiency of the neural network 102, provided by the inclusion of the brain emulation subnetwork 130, can allow the vehicle or drone to execute the operations of the neural network computing system 100 even when the vehicle or drone is resource-constrained. This efficiency can be especially important for time-sensitive tasks performed by the vehicle or drone, e.g., when a vehicle processes remote sensing data using the neural network to make a decision based on a prediction about the environment generated by the neural network, e.g., to determine whether to send an alert to a user in response to identifying an anomaly in the environment, as described above.

In some other implementations the operations of the neural network 102 when processing the remote sensing data 104 can be distributed across a system of multiple devices that are communicatively connected.

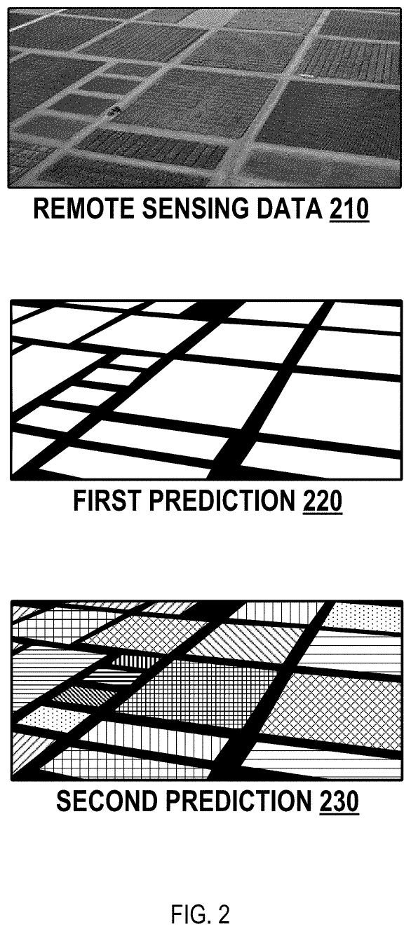

FIG. 2 illustrates example remote sensing data 210 and predictions 220 and 230 generated from the remote sensing data 210 by a brain emulation neural network.

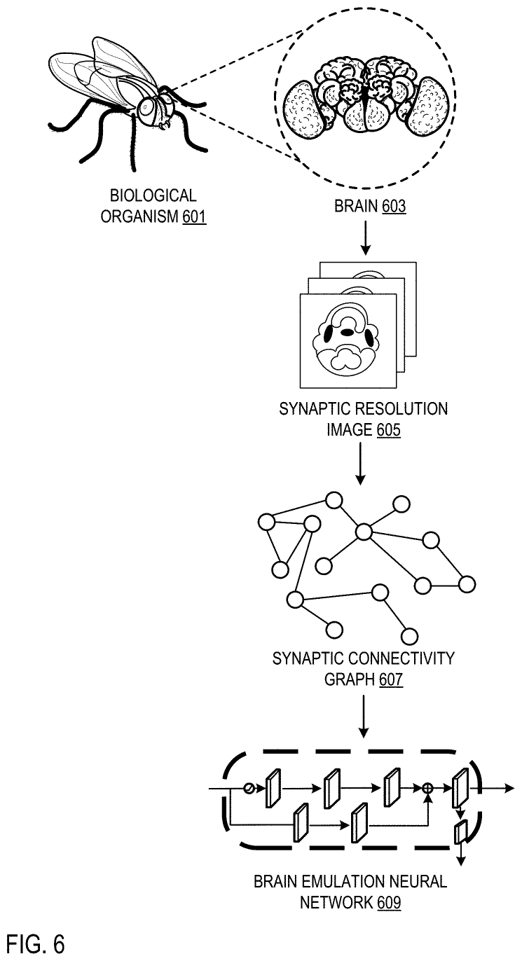

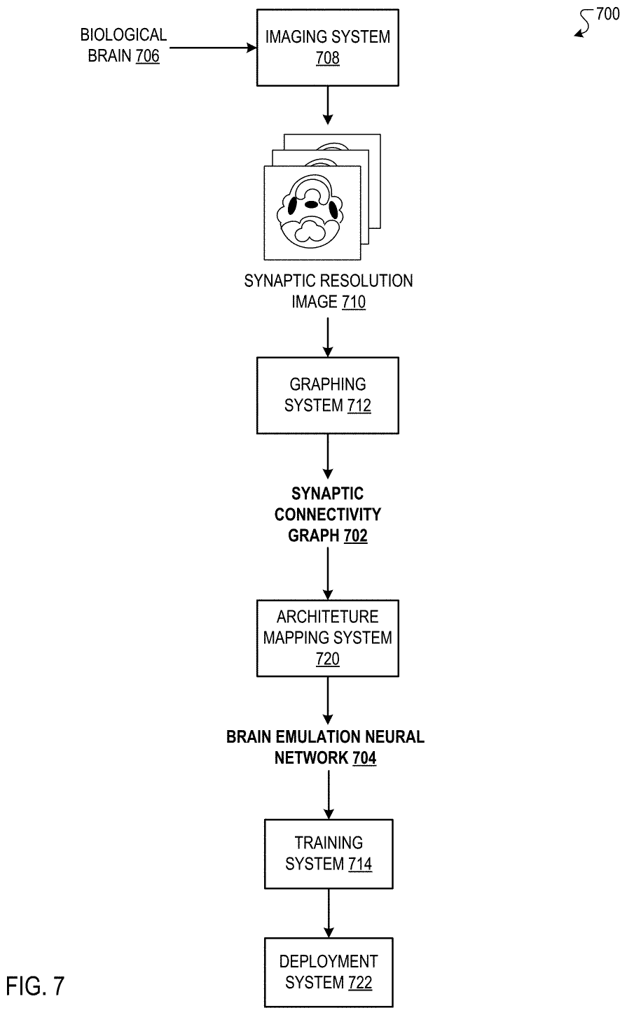

The brain emulation neural network can include one or more brain emulation neural network layers that are configured to process the remote sensing data 210 (or a respective hidden representations thereof) to generate the predictions 220 and 230. The network parameters and/or network architecture of the brain emulation neural network can be determined using biological connectivity between neuronal elements in the brain of the biological organism, as described in more detail below with reference to FIG. 6, FIG. 7, and FIG. 8. As a particular example, the brain emulation neural network can be configured similarly to the neural network 102 described above with reference to FIG. 1B.

The remote sensing data 210 characterizes an environment and has been generated by one or more sensors operating within or external to the environment. In particular, the remote sensing data 210 is an aerial image of multiple agricultural plots that has been captured by an on-board camera of an airplane or drone.

The brain emulation neural network can generate a first prediction 220 characterizing the environment of the remote sensing data 210, i.e., characterizing the agricultural plots depicted in the aerial image. In some implementations, as described above with reference to FIG. 1B, the brain emulation neural network generates a network output that is subsequently processed by a prediction engine to generate the first prediction 220.

The first prediction 220 represents a predicted binary semantic segmentation of the remote sensing data 210 into two classes: (i) a first class of pixels that represent respective agricultural plots (illustrated in FIG. 2 as white pixels) and (ii) a second class of pixels that do not represent agricultural plots (illustrated in FIG. 2 as black pixels). As described above with reference to FIG. 1B, in some implementations, the first prediction 220 can be further processed to generate one or more additional predictions about the agricultural plots, e.g., to identify a boundary for each agricultural plot depicted in the remote sensing data 210. Furthermore, a downstream machine learning model can determine a subset of the remote sensing data 210 to process according to the first prediction 220, e.g., by removing the pixels in the remote sensing data 210 assigned to the second class and only processing the pixels of the remote sensing data 210 assigned to the first class.

The second prediction 230 represents a predicted multi-class semantic segmentation of the remote sensing data 210 into multiple classes: (i) multiple different first classes corresponding to respective different types of crops (illustrated in FIG. 2 using respective different hatching patterns), where the pixels assigned to each first class depict an agricultural plot currently growing the crop corresponding to the first class, and (ii) a second class of pixels that do not represent any agricultural plots (illustrated in FIG. 2 as black pixels). As described above with reference to FIG. 1B, in some implementations, the second prediction 230 can be further processed to generate one or more additional predictions about the agricultural plots, e.g., a predicted yield of each different type of crop grown on respective agricultural plots depicted in the remote sensing data 210. Furthermore, a downstream machine learning model can determine a subset of the remote sensing data 210 to process according to the second prediction 230, e.g., by only processing the pixels of the remote sensing data 210 assigned to the first class corresponding to a particular crop type.

As depicted in FIG. 2, the remote sensing data 210 depicts the environment at an angle relative to the ground; that is, a line of sight of the one or more sensors that captured the remote sensing data 210 (in this example, the line of sight of the camera that captured the aerial image of the agricultural plots) was not perpendicular with the ground. In some implementations, a neural network computing system (e.g., the neural network computing system 100 described above with reference to FIG. 1B) first processes the remote sensing data 210 to generate updated data that depicts the environment from a perspective that is perpendicular to the ground. That is, the neural network computing system can apply one or more orthorectification techniques to project the remote sensing data 210 into a top-down coordinate system, generating updated data such that the spatial relationships between each pair of points in the environment are accurately represented in the updated data. The updated data can then be provided to the brain emulation neural network as a network input to generate the first prediction 220 or the second prediction 230.

In some other implementations, the brain emulation neural network does not require any orthorectification techniques to be applied to the remote sensing data 210 before processing. That is, the brain emulation neural network can be configured to generate predictions about remote sensing data captured at any angle relative to the environment. The brains of many biological organisms have been adapted by evolutionary pressures to have rotational invariance when processing sensory input; that is, the biological brains can apply spatially reasoning when interpreting an environment even when viewing the environment from an unfamiliar angle. Thus, by determining the network parameters of the brain emulation neural network using the biological connectivity between neuronal elements in the brain of a biological organism, the brain emulation neural network can be configured to generate accurate predictions from remote sensing data captured at many different angles relative to the environment.

For example, the non-biological neural network layers (and, optionally, the brain emulation neural network layers) of the brain emulation neural network can be trained using a training data set that includes remote sensing data 210 captured at a range of different angles relative to the environment. By processing, e.g., aerial images captured at different angles during training, the brain emulation neural network can be configured to generate accurate predictions without requiring any orthorectification preprocessing at inference time.

FIG. 3 illustrates an example block 300 of neural network layers that includes example connectivity neural network layers 310 and 340 and an example brain emulation subnetwork 330.

As described above, the connectivity neural network layers 310 and 340 immediately precede and follow, respectively, the brain emulation subnetwork 330 in the network architecture of a neural network. The neural network can be configured to process remote sensing data that has been captured by one or more sensors and that characterizes an environment.

In some implementations, the brain emulation subnetwork 330 can be at a location in the network architecture after an encoder subnetwork of the neural network and before a decoder subnetwork of the neural network. As a particular example, the brain emulation subnetwork 330 can be the brain emulation subnetwork 130 described above with reference to FIG. 1B. Generally, the brain emulation subnetwork 330 can be at any appropriate location in the network architecture of the neural network, e.g., before an encoder subnetwork of the neural network, after a decoder subnetwork of the neural network, in a “flat” portion of the network architecture (i.e., a portion of the network architecture where the size of the hidden representations of the network input to the neural network stays constant), and so on.

The block 300 of neural network layers is configured to receive as input encoded remote sensing data 302, which has been generated by one or more non-biological neural network layers preceding the block 300 in the network architecture of the neural network by processing the remote sensing data. In some implementations, the encoded remote sensing data 302 is the same as the remote sensing data; that is, the block 300 of neural network layers can be configured to process the remote sensing data directly.

Before processing the encoded remote sensing data 302 using the input connectivity neural network layer 310, the neural network divides the encoded remote sensing data 302 into N different input channels 304a-n, N>1. Although the encoded remote sensing data 302 is depicted as three-dimensional in FIG. 3, generally the input to the block 300 can have any dimensionality. Generally, each element of the encoded remote sensing data 302 can be included in exactly one input channel 304a-n.

In some implementations, each input channel 304a-n has a lower dimensionality than the encoded remote sensing data 302. For example, each input channel 304a-n can correspond to a respective different index along a particular dimension of the encoded remote sensing data 302, and includes every element of the encoded remote sensing data 302 having the respective index in the particular dimension. As a particular example, if the encoded remote sensing data 302 has size L₁×W₁, then the neural network can divide the encoded remote sensing data into L₁ input channels 304a-n (i.e., N=L₁), where each input channel has size W₁. As another particular example, if the encoded remote sensing data 302 has size L₁×W₁×H₁, then the neural network can divide the encoded remote sensing data into H₁ input channels 304a-n (i.e., N=H₁), where each input channel 304a-n has size L₁×W₁.

In some other implementations, each input channel 304a-n has the same dimensionality as the encoded remote sensing data 302. For example, if the encoded remote sensing data 302 is two-dimensional having size 100×100, then the neural network can divide the encoded remote sensing data into 100 input channels 304a-n each having size 10×10. As another example, if the encoded remote sensing data 302 is three-dimensional having size 100×100×100, then the neural network can divide the encoded remote sensing data into 1000 input channels 304a-n each having size 10×10×10.

Before training the neural network, a training system can randomly assign each position of the encoded remote sensing data 302 to one or more respective input channels 304a-n. Then, each time the neural network is executed, the neural network can assign the element at each position to the one or more input channels 304a-n corresponding to the position. That is, in some implementations, each element in the encoded remote sensing data 302 is included in exactly one input channel 304a-n, while in some other implementations, some or all of the elements in the encoded remote sensing data 302 are included in more than one input channel 304a-n.

For example, the input channels 304a-n can “overlap” each other within the encoded remote sensing data 302. As a particular example, if the encoded remote sensing data 302 is a one-dimensional input having ten elements, then the encoded remote sensing data 302 can be divided into four input channels 304a-n each having four elements, where elements 1-4 are assigned to the first input channel, elements 3-6 are assigned to the second input channel, elements 5-8 are assigned to the third input channel, and elements 7-10 are assigned to the fourth input channel.

In some implementations, each of the input channel 304a-n has the same size. In some other implementations, different input channels 304a-n can have different sizes. The input connectivity neural network layer 310 includes M different sub-layers 320a-n that are each configured to process a respective proper subset of the input channels 304a-n and to generate a respective updated channel 312a-m. That is, each input connectivity sub-layer 320a-m includes a subset of the parameters of the input connectivity layer 310, and uses the subset of the parameters to process the respective proper subset of input channels 304a-n to generate the respective updated channel 312a-m.

In some implementations, each of the updated channel 312a-m has the same size. In some other implementations, different input channels 312a-m can have different sizes.

Thus, the input connectivity neural network layer 310 is configured to process N input channels 304a-n and generate M updated channels 312a-m. In some implementations, M=N. For example, each input connectivity sub-layer 320a-m can be configured to process exactly one input channel 304a-n to generate the corresponding updated channel 312a-m, where each input channel 304a-n is processed by exactly one input connectivity sub-layer 320a-m. In some other implementations, M>N, such that at least one input channel 304a-n is processed by multiple different input connectivity sub-layers 320a-m. In some other implementations, N>M, such that at least one input connectivity sub-layer 320a-m is configured to process multiple different input channels 304a-n.

In some implementations, each input connectivity sub-layer is configured to process the same number of input channels 304a-n. In some other implementations, different input connectivity sub-layers can be configured to process a different number of input channels 304a-n. For example, the first input connectivity sub0layer 320a is configured to process one input channel 304a, while the M^{th} input connectivity sub-layer 320m is configured to process two input channels 304a and 304n.

In some implementations, each input channel 304a-n is processed by the same number of input connectivity sub-layers 320a-m. In some other implementations, different input channels 304a-n are processed by a different number of input connectivity sub-layers 320a-m. For example, the first input channel 304a is processed by one input connectivity sub-layer 320a, while the Nth input channel 304n is processed by two input connectivity sub-layers 320a and 320m.

In some implementations, for each input connectivity sub-layer 320a-m, the size of the updated channel 312a-m generated by the sub-layer is the same as the size of the input channels 304a-n processed by the sub-layer. In some other implementations (e.g., as depicted in FIG. 3), the size of the updated channel 312a-m generated by the sub-layer has a different size than the input channels 304a-n processed by the sub-layer. For example, the updated channel 312a-m generated by the sub-layer can have the same dimensionality as the input channels 304a-n processed by the sub-layer while having more or fewer parameters. As another example, the updated channel 312a-m generated by the sub-layer can have a different dimensionality than the input channels 304a-n processed by the sub-layer.

Each input connectivity sub-layer 320a-n can use any appropriate architecture to generate the respective updated channel 312a-m.

For example, each input connectivity sub-layer 320a-m can be a fully-connected neural network layer. In this example, dividing the encoded remote sensing data 302 into the input channels 304a-n can still improve the efficiency of the connectivity neural network layer 310 compared to processed the full encoded remote sensing data 302 using a fully-connected neural network layer. As an illustrative example, if N=M, and if each input channel 304a-n has size L₁×W₁ and each updated channel has size L₂×W₂, then the number of parameters of the input connectivity neural network layer 310 is N·(L₁·W₁) (L₂·W₂). If the input connectivity neural network layer 310 were a fully-connected neural network layer, then the number of parameters would be (L₁·W₁·N)·(L₂·W₂·N). Thus, dividing the encoded remote sensing data 302 into the input channels 304a-n improves the efficiency of the input connectivity neural network layer 310 by a factor of N.

As another example, each updated channel 312a-m can be a linear combination of the corresponding input channels 304a-n. That is, each input connectivity sub-layer 320a-m can generate its respective updated channel 312a-m by determining a weighted sum of its respective input channels 304a-n. As an illustrative example, if each sub-layer 320a-m processes k input channels 304a-n, then the input connectivity neural network layer 310 only has k M learned parameters, a significant efficiency improvement over the case, described above, where the input connectivity neural network layer 310 is a fully-connected layer.

As another example, each input connectivity sub-layer can process the corresponding proper subset of input channels 304a-n using a convolutional kernel.

The brain emulation subnetwork 330 is configured to process the updated channels 312a-m and to generate P brain emulation channels 332a-p, P>1. As described above, the parameters of the brain emulation subnetwork 330 can be determined using biological connectivity between neuronal elements in the brain of a biological organism. In some implementations, P=M. In some other implementations, P>M. In some other implementations, P<M.

In some implementations, each of the brain emulation channels 332a-p has the same size. In some other implementations, different brain emulation channels 332a-p can have different sizes.

In some implementations, the brain emulation subnetwork 330 does not process the updated channels 312a-m independently. Rather, the brain emulation subnetwork 330 can combine the updated channels 312a-m into a single brain emulation subnetwork input, and process the brain emulation subnetwork input to generate the brain emulation channels 332a-p.

In some implementations, the output of the brain emulation subnetwork 330 is not explicitly divided into the P brain emulation channels 332a-p. That is, the brain emulation subnetwork 330 can be configured to generate a single brain emulation output, and the neural network can then divide the brain emulation output into the brain emulation channels 332a-p. For example, the neural network can divide the brain emulation output in any way described above with reference to dividing the encoded remote sensing data 302.

In some implementations, the architecture of the brain emulation subnetwork 330 is represented using a weight matrix, where each element of the weight matrix is a respective parameter of the brain emulation subnetwork 330. Each element of the weight matrix can correspond to a pair of neuronal elements in the brain of the biological organism, where the value of the element characterizes a strength of a biological connection between the pair of neuronal elements. In other words, each row and column of the weight matrix can correspond to a respective neuronal element in the brain of the biological organism, and the value of each element characterizes a strength of a biological connection between (i) the neuronal element corresponding to the row of the element and (ii) the neuronal element corresponding to the column of the element. The process of generating the weight matrix is described in more detail below.

For example, the weight matrix of the brain emulation subnetwork 330 can have size M×P, such that the size of the brain emulation channels 332a-p is the same as the size of the updated channels 312a-m. In other words, each brain emulation channel 332a-p can be a linear combination of the updated channels 312a-m, where the linear combination corresponding to brain emulation channel 332i is defined by the i^{th} column of the weight matrix.

As another example, the brain emulation subnetwork 330 can be a fully-connected neural network layer. As an illustrative example, if the updated channels 312a-m have size L₂×W₂ and the brain emulation channels 332a-p have size L₃×W₃, then the weight matrix of the brain emulation subnetwork 330 has size (M·L₂·W₂)×(P·L₃·W₃).

In some implementations, the weight matrix is a square matrix where the same neuronal elements in the brain of the biological organism are represented by both the rows and the columns of the weight matrix.

The output connectivity neural network layer 340 is configured to process the brain emulation channels 332a-p to generate [symbol] output channels 352a-q, Q>1. The output connectivity neural network layer 340 can be configured similarly to the input connectivity layer 310. The output connectivity neural network layer 340 can have any of the configurations described above with reference to the input connectivity layer 310. In particular, the output connectivity neural network layer 340 can include [symbol] output connectivity sub-layers 350a-q that are each configured to process a respective proper subset of the brain emulation channels 332a-p to generate a respective output channel 352a-q.

The neural network can process the output channels 352a-q using one or more subsequent non-biological neural network layers of the neural network to generate network output for the neural network, i.e., to generate the prediction about the remote sensing data.

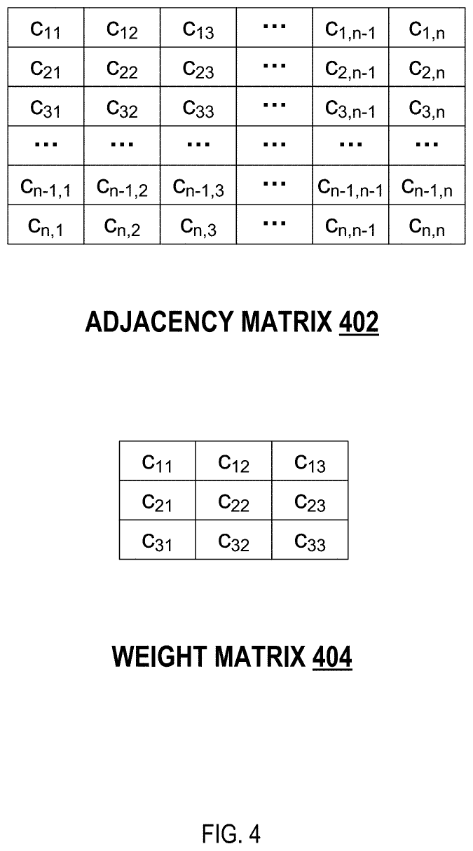

FIG. 4 illustrates an example weight matrix 404 of a brain emulation neural network layer determined using biological connectivity

As described in more detail below with reference to FIG. 7, a system (e.g., the graphing system 712 depicted in FIG. 7), can generate a synaptic connectivity graph that represents the biological connectivity between neuronal elements in the brain of the biological organism. The synaptic connectivity graph can be represented using an adjacency matrix 402, all of which or a portion of which can be used as the weight matrix 404 of the brain emulation neural network layer.

As illustrated in FIG. 4, the adjacency matrix 402 includes n² elements, where n is the number of neuronal elements drawn from the brain of the biological organism. For example, the adjacency matrix 402 can include hundreds, thousands, tens of thousands, hundreds of thousands, millions, tens of millions, or hundreds of millions of elements.

Each element of the adjacency matrix 402 represents the biological connectivity between a respective pair of neuronal elements in the set of n neuronal elements. That is, each element c_{i,j} identifies the biological connection between neuronal element i and neuronal element j. As described in more detail below, in some implementations, each of the elements c_{i,j} are either zero (representing that there is no biological connection between the corresponding neuronal elements) or one (representing that there is a biological connection between the corresponding neuronal elements), while in some other implementations, each element c_{i,j} is a scalar value representing the strength of the biological connection between the corresponding neuronal elements.

Each row and each column of the adjacency matrix 402 can represent a respective neuronal element in the brain of the biological organism. In particular, each row of the adjacency matrix 402 can represent a respective neuronal element in a first set of neuronal elements of the brain of the biological organism, and each column of the adjacency matrix 402 can represent a respective neuronal element in a second set of neuronal elements of the brain of the biological organism. Generally, the first set and the second set can be overlapping or disjoint. As a particular example, the first set and the second set can be the same.

In some implementations (e.g., in implementations in which the synaptic connectivity graph is undirected), the adjacency matrix 402 is symmetric (i.e., each element c_{i,j} is the same as element while in some other implementations (e.g., in implementations in which the synaptic connectivity graph is directed), the adjacency matrix 402 is not symmetric (i.e., there may exist elements c_{i,j} and c_{j,i} such that c_{i,j}≠c_{j,i}).

Although the above description refers to neuronal elements in the brain of the biological organism, generally the elements of the adjacency matrix can correspond to pairs of any appropriate component of the brain of the biological organism. For example, each element can correspond to a pair of voxels in a voxel grid of the brain of the biological organism.

As described in more detail below with reference to FIG. 7, an architecture mapping system (e.g., the architecture mapping system 720 depicted in FIG. 7) can generate the weight matrix 404 from the adjacency matrix 402. Generally, the elements of the weight matrix 404 (i.e., the brain emulation parameters of the brain emulation neural network layer) are a subset of the elements of the adjacency matrix 402. For example, as depicted in FIG. 4, the weight matrix 404 includes the elements of the adjacency matrix 402 representing biological connections between the neuronal elements represented by the first three rows and first three columns of the adjacency matrix 402. For example, the weight matrix 404 can represent only neuronal elements of a particular type in the brain of the biological organism. Identifying neuronal elements of a particular type is discussed in more detail below with reference to FIG. 8.

For convenience, the weight matrix 404 is illustrated as including only nine brain emulation parameters; generally, weight matrices of brain emulation neural network layers can have significantly more brain emulation parameters, e.g., hundreds, thousands, or millions of brain emulation parameters. Although the weight matrix 404 is depicted as square in FIG. 4 (i.e., the same number of columns and rows), generally the weight matrix 404 can have any appropriate dimensionality.

That is, generally the weight matrix 404 can be an M×N matrix, where each of the M rows corresponds to a neuronal element in a first set of neuronal elements and each of the N columns corresponds to a neuronal element in a second set of neuronal elements in the brain of the biological organism. The first set of neuronal elements and the second set of neuronal elements can be overlapping (i.e., one or more neuronal elements in the brain of the biological organism is in both sets) or disjoint (i.e., there does not exist a neuronal element in the brain of the biological organism that is in both sets). As a particular example, the first set and the second set can be the same. That is, the weight matrix 404 can be an N×N matrix where the same neuronal elements in the brain of the biological organism are represented by both the rows and the columns of the weight matrix. The process of generating the weight matrix is described in more detail below.

In some implementations, the weight matrix 404 represents the entire synaptic connectivity graph. That is, the weight matrix 404 can include a respective row and column for each node of the synaptic connectivity graph. The weight matrix 404 can be a sparse matrix, i.e., can include more than a threshold number or proportion of zero-value brain emulation parameters.

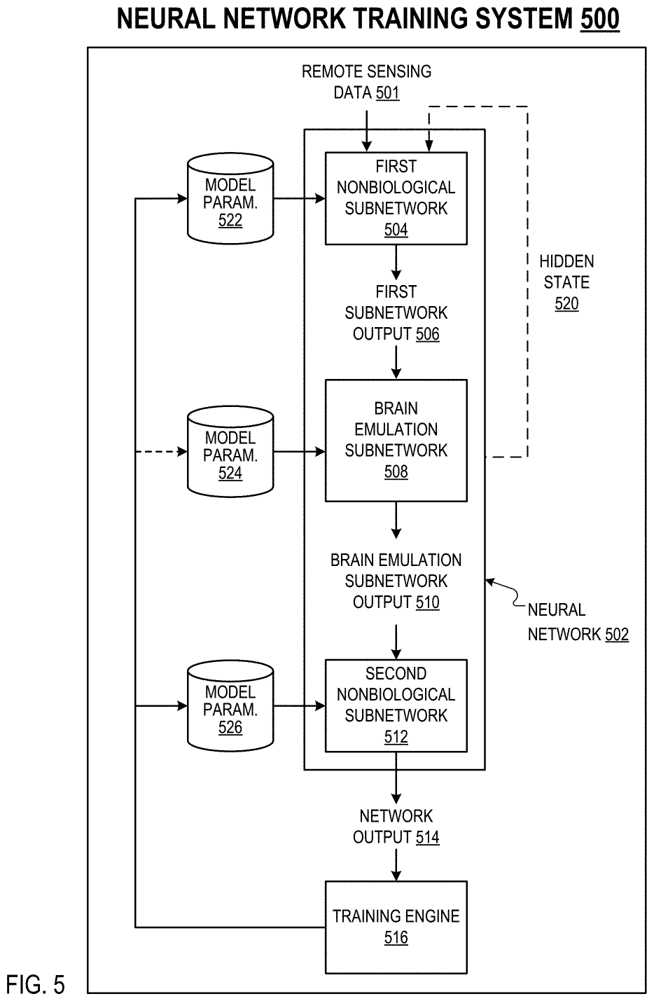

FIG. 5 shows an example neural network training system 500. The neural network computing system 500 is an example of a system implemented as computer programs on one or more computers in one or more locations in which the systems, components, and techniques described below are implemented.

The neural network computing system 500 includes a neural network 502 that has (at least) three subnetworks: (i) a first non-biological subnetwork 504 (ii) a brain emulation subnetwork 508, and (iii) a second non-biological subnetwork 512. The neural network 502 is configured to process remote sensing data 501 representing an environment, and to generate a network output 514 that represents a prediction about the environment.

The first non-biological subnetwork 504 is configured to process the remote sensing data 501 in accordance with a set of model parameters 522 of the first non-biological subnetwork 504 to generate a first subnetwork output 506. The final neural network layer of the first non-biological subnetwork 504 can be a connectivity neural network layer, e.g., the input connectivity neural network layer 120 depicted in FIG. 1B.

The brain emulation subnetwork 508 is configured to process the first subnetwork output 506 in accordance with a set of model parameters 524 of the brain emulation subnetwork 508 to generate a brain emulation subnetwork output 510. In this specification, the parameters of a brain emulation subnetwork or brain emulation neural network layer are also called “brain emulation parameters.”

The second non-biological subnetwork 512 is configured to process the brain emulation subnetwork output 510 in accordance with a set of model parameters 526 of the second non-biological subnetwork 512 to generate the network output 514. The first neural network layer of the second non-biological subnetwork 512 can be a connectivity neural network layer, e.g., the output connectivity neural network layer 140 depicted in FIG. 1B.

The brain emulation subnetwork can include one or more brain emulation neural network layers whose respective architectures have been determined using biological connectivity. For example, the brain emulation subnetwork 508 can be configured similarly to the brain emulation subnetwork 130 described above with reference to FIG. 1B.

Although the neural network 502 depicted in FIG. 5 includes one non-biological subnetwork 504 before the brain emulation subnetwork 508 and one non-biological subnetwork 512 after the brain emulation subnetwork 508, in general the neural network 502 can include any number of non-biological subnetworks before and/or after the brain emulation subnetwork 508. In some implementations, the first non-biological subnetwork 504 and/or the second non-biological subnetwork 512 can include only one or a few neural network layers (e.g., a single fully-connected layer) that processes the respective subnetwork input to generate the respective subnetwork output.

In implementations where there are zero non-biological subnetworks before the brain emulation subnetwork 508, the brain emulation subnetwork 508 can receive the remote sensing data 501 directly as input. In implementations where there are zero non-biological subnetworks after the brain emulation subnetwork 508, the brain emulation subnetwork output 510 can be the network output 514.

Although the neural network 502 depicted in FIG. 5 includes a single brain emulation subnetwork 508, in general the neural network 502 can include multiple brain emulation subnetwork 508. In some implementations, each brain emulation subnetwork 508 has the same set of brain emulation parameters 524; in some other implementations, each brain emulation subnetwork 508 has a different set of brain emulation parameters 524. In some implementations, each brain emulation subnetwork 508 has the same network architecture; in some other implementations, each brain emulation subnetwork 508 has a different network architecture.

In some implementations, the neural network 502 is a recurrent neural network. In these implementations, the remote sensing data 501 includes a sequence of input elements, e.g., a sequence of sets of remote sensing data each captured at respective different times in the environment. The first non-biological subnetwork 504 can process, at each of multiple time steps corresponding to respective input elements in the sequence, the input element to generate a respective first subnetwork output 506. At each time step, the brain emulation subnetwork 508 can process the first subnetwork output 506 to generate a respective brain emulation subnetwork output 510. At each time step, the second non-biological subnetwork 512 can process the brain emulation subnetwork output 510 to generate an output element corresponding to the input element.

At each time step, the neural network 502 can maintain a hidden state 520. That is, at each time step, the neural network 502 updates its hidden state 520; then, at the subsequent time step in the sequence of time steps, the neural network 502 receives as input (i) the input element of the network input 501 corresponding to the subsequent time step and (ii) the current hidden state 520.

In some implementations in which the neural network 502 is a recurrent neural network (e.g., in the example depicted in FIG. 5), the first non-biological subnetwork 504 receives both i) the input element of the sequence of the remote sensing data 501 and ii) the hidden state 520. For example, the recurrent neural network 502 can combine the input element and the hidden state 520 (e.g., through concatenation, addition, multiplication, or an exponential function) to generate a combined input, and then process the combined input using the first non-biological subnetwork 504.

In some implementations in which the neural network 502 is a recurrent neural network, the brain emulation subnetwork 508 receives as input the hidden state 520 and the first subnetwork output 506. For example, the neural network 502 can combine the first subnetwork output 506 and the hidden state 520 (e.g., through concatenation, addition, multiplication, or an exponential function) to generate a combined input, and then process the combined input using the brain emulation subnetwork 508.

In some implementations in which the neural network 502 is a recurrent neural network, the second non-biological subnetwork 512 receives as input the hidden state 520 and the brain emulation subnetwork output 510. For example, the neural network 502 can combine the brain emulation subnetwork output 510 and the hidden state 520 (e.g., through concatenation, addition, multiplication, or an exponential function) to generate a combined input, and then process the combined input using the second non-biological subnetwork 512.

In some implementations in which the neural network 502 is a recurrent neural network, the updated hidden state 520 generated at a time step is the same as the output element generated at the time step. In some other implementations, the hidden state 520 is an intermediate output of the neural network 502. An intermediate output refers to an output generated by a hidden artificial neuron or a hidden neural network layer of the neural network 502, i.e., an artificial neuron or neural network layer that is not included in the input layer or the output layer of the neural network 502. For example, the hidden state 520 can be the brain emulation subnetwork output 510. In some other implementations, the hidden state 520 is a combination of the output element and one or more intermediate outputs of the neural network 502. For example, the hidden state 520 can be computed using the output element and the brain emulation subnetwork output 510, e.g., by combining the two outputs and applying an activation function.

In some implementations in which the neural network 502 is a recurrent neural network, after each input element in the remote sensing data 501 has been processed by the recurrent neural network 502 to generate respective output elements, the recurrent neural network 502 can generate a network output 514 corresponding to the remote sensing data 501. In some such implementations, the network output 514 is the sequence of generated outputs elements. In some other implementations, the network output 514 is a subset of the generated output elements, e.g., the final output element corresponding to the final input element in the sequence of input elements of the remote sensing data 501. In some other implementations, the recurrent neural network 502 further processes the sequence of generated output elements to generate the network output 514. For example, the network output 514 can be the mean of the generated output elements.

In some implementations, the brain emulation subnetwork 508 itself has a recurrent neural network architecture. That is, the brain emulation subnetwork 508 can process the first subnetwork output 506 multiple times at respective sub-time steps (referred to as sub-time steps to differentiate from the time steps of the neural network 502 in implementations where the neural network 502 is a recurrent neural network).

For example, the architecture of the brain emulation subnetwork 508 can include a sequence of components (e.g., brain emulation neural network layers or groups of brain emulation neural network layers) such that the architecture includes a connection from each component in the sequence to the next component, and the first and last components of the sequence are identical. In one example, two brain emulation neural network layers that are each directly connected to one another (i.e., where the first layer provides its output the second layer, and the second layer provides its output to the first layer) would form a recurrent loop. A recurrent brain emulation subnetwork 508 can process the first subnetwork output 506 over multiple sub-time steps to generate a respective brain emulation subnetwork output 510 at each sub-time step. In particular, at each sub-time step, the brain emulation subnetwork 508 can process: (i) the first subnetwork output 506 (or a component of the first subnetwork output 506), and (ii) any outputs generated by the brain emulation subnetwork 508 at the preceding sub-time step, to generate the brain emulation subnetwork output 510 for the sub-time step. The neural network 502 can provide the brain emulation subnetwork output 510 generated by the brain emulation subnetwork 508 at the final sub-time step as the input to the second non-biological subnetwork 512. The number of sub-time steps over which the brain emulation subnetwork 508 processes remote sensing data can be a predetermined hyper-parameter of the neural network computing system 500.

In some implementations, in addition to processing the brain emulation subnetwork output 510 generated by the output layer of the brain emulation subnetwork 508, the second non-biological subnetwork 512 can additionally process one or more intermediate outputs of the brain emulation subnetwork 508.

The neural network computing system 500 includes a training engine 516 that is configured to train the neural network 502.

In some implementations, the brain emulation parameters 524 for the brain emulation subnetwork 508 are untrained. Instead, the brain emulation parameters 524 of the brain emulation subnetwork 508 can be determined before the training of the non-biological subnetworks 504 and 512 based on the weight values of the edges in a synaptic connectivity graph representing biological connectivity between neuronal elements in the brain of a biological organism. Optionally, the weight values of the edges in the synaptic connectivity graph can be transformed (e.g., by additive random noise) prior to being used for specifying brain emulation parameters 524 of the brain emulation subnetwork 508. This procedure enables the neural network 502 to take advantage of the information from the synaptic connectivity graph encoded into the brain emulation subnetwork 508 in performing prediction tasks.

Therefore, rather than training the entire neural network 502 from end-to-end, the training engine 516 can train only the model parameters 522 of the first non-biological subnetwork 504 and the brain emulation parameters 526 of the second non-biological subnetwork 512, while leaving the brain emulation parameters 524 of the brain emulation subnetwork 508 fixed during training.

The training engine 516 can train the neural network 502 on a set of training data over multiple training iterations. The training data can include a set of training examples, where each training example specifies: (i) a training input that includes or has been generated from a set of remote sensing data representing a respective environment, and (ii) a target network output that should be generated by the neural network 502 by processing the training network input. In some implementations, the target network outputs are human-labeled target outputs. In some implementations, each training input has been generated from remote sensing data representing the same environment; in some other implementations, different training inputs have been generated from remote sensing data representing respective different environments.

At each training iteration, the training engine 516 can sample a batch of training examples from the training data, and process the training inputs specified by the training examples using the neural network 502 to generate corresponding network outputs 514. In particular, for each training input, the neural network 502 processes the training input using the current model parameter values 522 of the first non-biological subnetwork 504 to generate a first subnetwork output 506. The neural network 502 processes the first subnetwork output 506 in accordance with the static brain emulation parameters 524 of the brain emulation subnetwork 508 to generate a brain emulation subnetwork output 510. The neural network 502 then processes the brain emulation subnetwork output 510 using the current model parameter values 526 of the second non-biological subnetwork 512 to generate the network output 514 corresponding to the training input.

The training engine 516 adjusts the model parameters values 522 of the first non-biological subnetwork 504 and the model parameter values 526 of the second non-biological subnetwork 512 to optimize an objective function that measures a similarity between: (i) the network outputs 514 generated by the neural network 502, and (ii) the target network outputs specified by the training examples. The objective function can be, e.g., a cross-entropy objective function, a squared-error objective function, or any other appropriate objective function.

To optimize the objective function, the training engine 516 can determine gradients of the objective function with respect to the model parameters 522 of the first non-biological subnetwork 504 and the model parameters 526 of the second non-biological subnetwork 512, e.g., using backpropagation techniques. The training engine 516 can then use the gradients to adjust the model parameter values 522 and 526, e.g., using any appropriate gradient descent optimization technique, e.g., an RMSprop or Adam gradient descent optimization technique.

The training engine 516 can use any of a variety of regularization techniques during training of the neural network 502. For example, the training engine 516 can use a dropout regularization technique, such that certain artificial neurons of the neural network 502 are “dropped out” (e.g., by having their output set to zero) with a non-zero probability p>0 each time the neural network 502 processes a network input. Using the dropout regularization technique can improve the performance of the trained neural network 502, e.g., by reducing the likelihood of over-fitting. As another example, the training engine 516 can regularize the training of the neural network 502 by including a “penalty” term in the objective function that measures the magnitude of the model parameter values 522 and 526 of the non-biological subnetworks 504 and 512. The penalty term can be, e.g., an L₁ or L₂ norm of the model parameter values 522 of the first non-biological subnetwork 504 and/or the model parameter values 526 of the second non-biological subnetwork 512.

In some other implementations, the brain emulation parameters 524 for the brain emulation subnetwork 508 are trained. That is, after initial values for the brain emulation parameters 524 of the brain emulation subnetwork 508 have been determined based on the weight values of the edges in the synaptic connectivity graph, the training engine 516 can update the weights of the brain emulation parameters, as described above with reference to the parameters 522 and 526 of the non-biological subnetworks, e.g., using backpropagation and stochastic gradient descent.

In some implementations, the some or all of the brain emulation parameters 524 (e.g., the brain emulation parameters for a particular brain emulation neural network layer of the brain emulation subnetwork 508) are represented by a sparse weight matrix. In this specification, a matrix may be referred to as a “sparse matrix” if the sparsity of the matrix (i.e., the number or proportion of zero-value elements of the matrix) satisfies a certain threshold. For example, in some implementations the weight matrix of a brain emulation neural network layer has a sparsity of 50% (i.e., where 50% of the brain emulation parameters of the weight matrix have a value of zero), 60%, 70%, 80%, 90%, 95%, or 99%.

In some such implementations, when updating the brain emulation parameters of a sparse weight matrix, the training engine 516 keeps the zero-value elements of the sparse weight matrix constant, i.e., at zero. If the training engine 516 executed backpropagation and gradient descent across all the values of the weight matrix, zero-value brain emulation parameters of the weight matrix would likely be updated to non-zero values. Because the weight matrix represents biological connectivity between neuronal elements in the brain of a biological organism, updating a zero-value brain emulation parameter to have a non-zero value corresponds to incorrectly representing biological connectivity between the pair of neuronal elements represented by the brain emulation parameter, when no such biological connectivity was measured in the brain of the biological organism. Thus, in some implementations in which fidelity to the measured biological connectivity is important, the training engine 516 avoids inserting representations of new and incorrect biological connections by freezing the zero-value brain emulation parameters at zero.

In some other such implementations, the training engine 516 does update some or all of the zero-value brain emulation parameters of the weight matrix to have a non-zero value. Instead or in addition, the training engine 516 can update one or more non-zero brain emulation parameters of the weight matrix to have a value zero, and freeze the value at zero.

For example, the training engine 516 can execute an artificial evolutionary procedure whereby, over multiple training stages, the training engine 516 iteratively removes the brain emulation parameters representing the weakest biological connections in the brain of the biological organism from the weight matrix. The training engine 516 can also add new brain emulation parameters to the weight matrix, where the new brain emulation parameters represent “new” biological connections in the brain of the biological organism (i.e., biological connections that were not measured in the brain of the biological organism).

This procedure is referred to as “evolutionary” because it simulates, across the multiple training stages, the removal of “weak” brain emulation parameters (e.g., brain emulation parameters with the lowest value or magnitude) and the addition of new brain emulation parameters that may improve the performance of the neural network 502. Performing the evolutionary procedure can further reduce the amount of training data and the number of training iterations required to train the neural network 502 to achieve an acceptable level of performance, e.g., as measured by prediction accuracy.

For example, at each of one or more training stages during the training of the neural network 502, the training engine 516 can stochastically sample (i.e., select) non-zero brain emulation parameters of the weight matrix, and remove the sampled non-zero brain emulation parameters from the weight matrix.

As a particular example, the training engine 516 can sample each non-zero brain emulation parameter with a uniform likelihood. That is, each non-zero brain emulation parameter can have the same likelihood of being selected, regardless of the value of the parameter or the position of the parameter within the weight matrix. As another particular example, the training engine 516 can determine the N non-zero brain emulation parameters that have the lowest respective magnitudes, N>1, and sample the N non-zero brain emulation parameters uniformly. For instance, N can be a predetermined integer, or N can be a predetermined fraction of the total number of non-zero brain emulation parameters in the weight matrix.

As another particular example, the training engine 516 can sample each non-zero brain emulation parameter with a likelihood that is inversely proportional with the magnitude of its value. That is, non-zero brain emulation parameters with lower magnitudes can be more likely to be selected than non-zero brain emulation parameters with higher magnitudes.

In some such implementations, the training engine 516 can determine the likelihood of sampling each non-zero brain emulation parameter to be equal to the softmax of the negated magnitude of the non-zero brain emulation parameter. That is, the training engine 516 can compute:

$${p}_{i} = \frac{{e}^{- \vert {x}_{i} \vert}}{{Σ}_{j} {e}^{- \vert {x}_{j} \vert}}$$

where xᵢ is the value of the i^{th} non-zero brain emulation parameter and pᵢ is the likelihood with which the i^{th} non-zero brain emulation parameter is sampled by the training engine 516.

In some other such implementations, the training engine 516 can determine the likelihood of sampling each non-zero brain emulation parameter to be equal to the softmax of the inverse magnitude of the non-zero brain emulation parameter. That is, the training engine 516 can compute:

$${p}_{i} = \frac{{e}^{1 / \vert {x}_{i} \vert}}{{Σ}_{j} {e}^{1 / \vert {x}_{j} \vert}}$$

In some other such implementations, the training engine 516 can determine the N non-zero brain emulation parameters that have the lowest respective magnitudes, N>1, and sample the N non-zero brain emulation parameters according to either of the softmax equations described above.

As another particular example, the training engine 516 can sample each represented brain emulation parameter with a likelihood that is inversely proportional to the rank of the non-zero brain emulation parameter in a ranking of the non-zero brain emulation parameters of the weight matrix. That is, non-zero brain emulation parameters with lower ranks in the ranking of the magnitudes can be more likely to be selected than non-zero brain parameters with higher ranks in the ranking of the magnitudes. In some such implementations, the training engine 516 can determine the N non-zero brain emulation parameters that have the lowest respective ranks in the ranking of the magnitudes, N>1, and sample the N non-zero brain emulation parameters according to their respective ranks.

As another example, the training engine 516 can execute a two-step process for stochastically sampling the non-zero brain emulation parameters of the weight matrix. In the first step of the two-step process, the training engine 516 can generate a set of candidate non-zero brain emulation parameters by sampling the non-zero brain emulation parameters according to a ranking of their magnitudes. In the second step of the two-step process, the training engine 516 can sample from the set of non-zero brain emulation parameters according to their magnitudes (e.g., using a softmax function as described above). The training engine 516 can then remove the candidate non-zero brain emulation parameters sampled in the second step from the weight matrix.

In some implementations, the training engine 516 removes the same number of non-zero brain emulation parameters at each training stage. In some other implementations, the training engine 516 can sample a different number of non-zero brain emulation parameters at each training stage.

Instead of or in addition to removing non-zero brain emulation parameters from the compressed matrix representation, the training engine 516 can add “new” non-zero brain emulation parameters to the weight matrix at each of one or more training stages. For example, the training engine 516 can randomly sample one or more zero-value brain emulation parameters of the weight matrix, generate values for the sampled zero-value brain emulation parameters, and insert the sampled zero-value brain emulation parameters, having the respective generated values, into the weight matrix as newly-non-zero brain emulation parameters.

For example, the training engine 516 can sample a respective value for each new non-zero brain emulation parameter from a predefined distribution, e.g., a uniform distribution between 0 and 1 or a Normal distribution with mean 0.

As another example, the training engine 516 can determine the initial value of the new non-zero brain emulation parameters to be 0. Then, during training of the neural network 502, the value of these new non-zero brain emulation parameters can be updated to actually have non-zero values, e.g., using stochastic gradient descent.

In some implementations, the training engine 516 samples the same number of zero-value brain emulation parameters as the number of non-zero value brain emulation parameters sampled as described above. That is, the weight matrix can include the same number of non-zero brain emulation parameters before and after the training stage. In some other implementations, the training engine 516 samples a different number of non-zero and zero-value brain emulation parameters during a given training stage, such that the number of non-zero brain emulation parameters in the weight matrix changes.

In some implementations, the training engine 516 can sample new non-zero brain emulation parameters to add to the weight matrix such that the sampled new non-zero brain emulation parameters are biologically plausible. That is, the training engine 516 can ensure that each new non-zero brain emulation parameter represents a pair of neuronal elements that could plausibly share a biological connection in the brain of the biological organism. For example, the training engine 516 can sample new non-zero brain emulation parameters corresponding to pairs of neuronal elements in the same region of the brain of the biological organism.

In some implementations, the training engine 516 trains multiple different versions of the neural network 502, e.g., using respective different hyper-parameter values for a set of hyper-parameters of the neural network 502. The training engine 516 can then select the version of the neural network 502 that has the highest performance (e.g., as measured by prediction accuracy) for deployment. As described above, the presence of the brain emulation subnetwork 508 can significantly reduce the amount of time required to train a version of the neural network. For example, while some existing techniques require that a neural network be trained over hundreds of thousands or millions of training steps, the inclusion of the brain emulation neural network 508 can allow the neural network 102 to be trained in merely 10, 50, 100, or 500 training steps. Therefore, inserting the brain emulation subnetwork 508 into the network architecture of the neural network 502 can allow the training engine 516 to train many more different versions of the neural network 502 using a constant computational budget. Therefore, the training engine 516 can do a more exhaustive search of the space of hyper-parameter values in a reduced amount of time, providing the opportunity for the training engine 516 to train superior versions of the neural network 502 than if the neural network 502 did not include the brain emulation subnetwork 508.

In some implementations, the training engine 516 trains the neural network 502 to perform multiple different machine learning tasks using the remote sensing data 501; that is, the neural network 502 can be configured to generate a network output 514 that includes multiple different predictions about the environment represented by the remote sensing data 501. For example, the neural network 502 can include multiple “head” subnetworks (e.g., head subnetworks of the second non-biological subnetwork 512) that each correspond to a respective machine learning task. Each head subnetwork can process a hidden representation of the remote sensing data 501 (e.g., each head subnetwork can process the same hidden representation generated by a preceding neural network layer of the second non-biological subnetwork 512) and generate a prediction corresponding to the respective machine learning task. The network output 514 can then include each prediction generated by a respective head subnetwork. As a particular example, each head subnetwork can include only one or a few non-biological neural network layers, e.g., feedforward neural network layers.

For example, one of the machine learning tasks is considered the “primary” machine learning task, while the one or more other machine learning tasks are considered “auxiliary” machine learning tasks. The training engine 516 can train the neural network 502 to perform the auxiliary machine learning tasks in order to improve the performance of the neural network 502 on the primary machine learning task. The auxiliary machine learning tasks can be tasks that complement the primary machine learning task. Thus, by updating the model parameters 522 and 526 (and, optionally, the brain emulation parameters 524) according to an error in the predictions for the respective auxiliary machine learning tasks, the training engine 516 can improve the performance of the model parameters 522 and 526 on the primary machine learning task.

The one or more auxiliary machine learning tasks can be include any appropriate task, e.g., one or more of the machine learning tasks described above with reference to the neural network computing system 100. As further examples, if the remote sensing data 501 includes images of the environment, then the auxiliary machine learning tasks can include one or more of: predicting the time of day at which the remote sensing data 501 was captured, the season of the year during which the remote sensing data 501 was captured, or the date on which the remote sensing data 501 was captured; or predicting weather conditions in the environment at the time the remote sensing data 501 was captured. By learning to differentiate between different times, seasons, weather patterns, and so on, the neural network 502 can simultaneously learn to generate predictions for the primary machine learning task regardless of such confounding factors, e.g., even if the images are darker because of the time of day or include artifacts as a result of rain.

In some implementations, after the neural network 502 has been trained, the neural network 502 only performs the primary machine learning task at inference time. Thus, the neural network 502 can be deployed only with the head subnetwork corresponding to the primary machine learning task; that is, the head subnetworks corresponding to respective auxiliary machine learning tasks can be removed before deployment.

In some other implementations, multiple (e.g., each) of the machine learning tasks for which the neural network 502 is trained are performed at inference time. For example, the neural network 502 can be configured to efficiently perform multiple machine learning tasks by processing the remote sensing data 501 in a single forward pass. This efficiency can be particularly important in implementations in which the neural network 502 is deployed in resource-constrained environments after training, e.g., when the neural network 502 is deployed on a field device, drone, or plane.

Generally, after training, the neural network 502 can be directly applied to perform prediction tasks. For example, the neural network 502 can be deployed onto a user device. In some implementations, the neural network 502 can be deployed directly into resource-constrained environments (e.g., mobile devices). Neural networks 502 that include brain emulation subnetworks 508 can generally perform at a high level, e.g., in terms of prediction accuracy, even with very few model parameters compared to other neural networks. For example, neural networks 502 as described in this specification that have, e.g., 100 or 1000 model parameters can achieve comparable performance to other neural networks that have millions of model parameters. Thus, the neural network 502 can be implemented efficiently and with low latency on user devices.

In some implementations, after the neural network 502 has been deployed onto a user device, some of the parameters of the neural network 502 can be further trained, i.e., “fine-tuned,” using new training example obtained by the user device. For example, some of the parameters can be fine-tuned using training example corresponding to the specific user of the user device, so that the neural network 502 can achieve a higher accuracy for inputs provided by the specific user. As a particular example, the model parameters 522 of the first non-biological subnetwork 504 and/or the model parameters 526 of the second non-biological subnetwork 512 can be fine-tuned on the user device using new training examples while the model parameters 524 of the brain emulation subnetwork 508 are held static, as described above.

FIG. 6 illustrates an example of generating an artificial (i.e., computer implemented) brain emulation neural network 609 based on a synaptic resolution image 605 of the brain 603 of a biological organism 601, e.g., a fly.

The synaptic resolution image 605 can be processed to generate a synaptic connectivity graph 607. The synaptic connectivity graph 607 represents synaptic connectivity between neuronal elements in the brain 603 of the biological organism 601. A “neuronal element” can refer to an individual neuron, a portion of a neuron, a group of neurons, or any other appropriate biological element in the brain 603 of the biological organism 601. As will be described in more detail below with reference to FIG. 8, the synaptic connectivity graph 607 can include multiple nodes and multiple edges, where each edge connects a respective pair of nodes. At least a subset of the nodes of the synaptic connectivity graph 607 can represent respective neuronal elements in the brain 603 of the biological organism, and each edge between pairs of nodes in the subset can represent a biological connection between the pair of neuronal elements corresponding to the pair of nodes. In one example, each node in the graph 108 can represent an individual neuron, and each edge connecting a pair of nodes in the graph 108 can represent a respective synaptic connection between the corresponding pair of individual neurons.

In some implementations, the synaptic connectivity graph 607 can be an “over-segmented” synaptic connectivity graph, e.g., where at least some nodes in the graph represent a portion of a neuron, and at least some edges in the graph connect pairs of nodes that represent respective portions of neurons. In some implementations, the synaptic connectivity graph 607 can be a “contracted” synaptic connectivity graph, e.g., where at least some nodes in the graph represent a group of neurons, and at least some edges in the graph represent respective connections (e.g., nerve fibers) between such groups of neurons. In some implementations, the synaptic connectivity graph 607 can include features of both the “over-segmented” graph and the “contracted” graph. Generally, the synaptic connectivity graph 607 can include nodes and edges that represent any appropriate neuronal element, and any appropriate biological connection between a pair of neuronal elements, respectively, in the brain 603 of the biological organism 601.

The structure of the synaptic connectivity graph 607 can be used to specify the architecture of the brain emulation neural network 609. For example, each node of the graph 607 can be mapped to an artificial neuron, a neural network layer, or a group of neural network layers in the brain emulation neural network 609. Further, each edge of the graph 607 can be mapped to a connection between artificial neurons, layers, or groups of layers in the brain emulation neural network 609. The brain 603 of the biological organism 601 can be adapted by evolutionary pressures to be effective at solving certain tasks, e.g., classifying objects or generating robust object representations, and the brain emulation neural network 609 can share this capacity to effectively solve tasks.

FIG. 7 shows an example data flow 700 for generating a synaptic connectivity graph 702 and a brain emulation neural network 704 based on the brain 706 of a biological organism. As used throughout this document, a brain may refer to any amount of nervous tissue from a nervous system of a biological organism, and nervous tissue may refer to any tissue that includes neurons (i.e., nerve cells). The biological organism can be, e.g., a worm, a fly, a mouse, a cat, or a human.

An imaging system 708 can be used to generate a synaptic resolution image 710 of the brain 706. An image of the brain 706 may be referred to as having synaptic resolution if it has a spatial resolution that is sufficiently high to enable the identification of at least some synapses in the brain 706. Put another way, an image of the brain 706 may be referred to as having synaptic resolution if it depicts the brain 706 at a magnification level that is sufficiently high to enable the identification of at least some synapses in the brain 706. The image 710 can be a volumetric image, i.e., that characterizes a three-dimensional representation of the brain 706. The image 710 can be represented in any appropriate format, e.g., as a three-dimensional array of numerical values.

The imaging system 708 can be any appropriate system capable of generating synaptic resolution images, e.g., an electron microscopy system. The imaging system 708 can process “thin sections” from the brain 706 (i.e., thin slices of the brain attached to slides) to generate output images that each have a field of view corresponding to a proper subset of a thin section. The imaging system 708 can generate a complete image of each thin section by stitching together the images corresponding to different fields of view of the thin section using any appropriate image stitching technique. The imaging system 708 can generate the volumetric image 710 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system 712 is configured to process the synaptic resolution image 710 to generate the synaptic connectivity graph 702. The synaptic connectivity graph 702 specifies a set of nodes and a set of edges, such that each edge connects two nodes. To generate the graph 702, the graphing system 712 identifies each neuronal element (e.g., each neuron, portion of a neuron, or group of neurons) in the image 710 as a respective node in the graph, and identifies each biological connection between a pair of neuronal elements in the image 710 as an edge between the corresponding pair of nodes in the graph.

The graphing system 712 can identify the neuronal elements and the biological connections depicted in the image 710 using any of a variety of techniques. For example, the graphing system 712 can process the image 710 to identify the positions of the neuronal elements depicted in the image 710, and determine whether a biological connection connects two neuronal elements based on the proximity of the neuronal elements (as will be described in more detail below). In this example, the graphing system 712 can process an input including: (i) the image, (ii) features derived from the image, or (iii) both, using a machine learning model that is trained using supervised learning techniques to identify neuronal elements in images. The machine learning model can be, e.g., a convolutional neural network model or a random forest model. The output of the machine learning model can include a neuronal element probability map that specifies a respective probability that each voxel in the image is included in a neuronal element. The graphing system 712 can identify contiguous clusters of voxels in the neuronal element probability map as being neuronal elements.

Optionally, prior to identifying the neuronal elements from the neuronal element probability map, the graphing system 712 can apply one or more filtering operations to the neuronal element probability map, e.g., with a Gaussian filtering kernel. Filtering the neuronal element probability map can reduce the amount of “noise” in the neuronal element probability map, e.g., where only a single voxel in a region is associated with a high likelihood of being a neuronal element.

The machine learning model used by the graphing system 712 to generate the neuronal element probability map can be trained using supervised learning training techniques on a set of training data. The training data can include a set of training examples, where each training example specifies: (i) a training input that can be processed by the machine learning model, and (ii) a target output that should be generated by the machine learning model by processing the training input. For example, the training input can be a synaptic resolution image of a brain, and the target output can be a “label map” that specifies a label for each voxel of the image indicating whether the voxel is included in a neuronal element. The target outputs of the training examples can be generated by manual annotation, e.g., where a person manually specifies which voxels of a training input are included in neuronal elements.

Example techniques for identifying the positions of neuronal elements depicted in the image 710 using neural networks (in particular, flood-filling neural networks) are described with reference to: P.H. Li et al.: “Automated Reconstruction of a Serial-Section EM Drosophila Brain with Flood-Filling Networks and Local Realignment,” bioRxiv doi:10.1101/605634 (2019).

The graphing system 712 can identify the biological connections connecting the neuronal elements in the image 710 (e.g., the synapses connecting the neurons in the image 710) based on the proximity of the neuronal elements. For example, the graphing system 712 can determine that a first neuronal element is connected by a biological connection to a second neuronal element based on the area of overlap between: (i) a tolerance region in the image around the first neuronal element, and (ii) a tolerance region in the image around the second neuronal element. That is, the graphing system 712 can determine whether the first neuronal element and the second neuronal element are connected based on the number of spatial locations (e.g., voxels) that are included in both: (i) the tolerance region around the first neuronal element, and (ii) the tolerance region around the second neuronal element. For example, the graphing system 712 can determine that two neuronal elements are connected if the overlap between the tolerance regions around the respective neuronal elements includes at least a predefined number of spatial locations (e.g., one spatial location). A “tolerance region” around a neuronal element refers to a contiguous region of the image that includes the neuronal element. For example, the tolerance region around a neuronal element can be specified as the set of spatial locations in the image that are either: (i) in the interior of the neuronal element, or (ii) within a predefined distance of the interior of the neuronal element.

The graphing system 712 can further identify a weight value associated with each edge in the graph 702. For example, the graphing system 712 can identify a weight for an edge connecting two nodes in the graph 702 based on the area of overlap between the tolerance regions around the respective neuronal elements corresponding to the nodes in the image 710. The area of overlap can be measured, e.g., as the number of voxels in the image 710 that are contained in the overlap of the respective tolerance regions around the neuronal elements. The weight for an edge connecting two nodes in the graph 702 may be understood as characterizing the (approximate) strength of the connection between the corresponding neuronal elements in the brain (e.g., the amount of information flow through the synapse connecting the two neurons).

In addition to identifying biological connections in the image 710, the graphing system 712 can further determine the direction of each biological connection using any appropriate technique. The “direction” of a biological connection between two neuronal elements refers to the direction of information flow between the two neuronal elements, e.g., if a first neuronal element uses a biological connection to transmit signals to a second neuronal element, then the direction of the biological connection would point from the first neuronal element to the second neuronal element. Example techniques for determining the directions of biological connections connecting pairs of neuronal elements are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system 712 determines the directions of the biological connections in the image 710, the graphing system 712 can associate each edge in the graph 702 with the direction of the corresponding biological connection. That is, the graph 702 can be a directed graph. In some other implementations, the graph 702 can be an undirected graph, i.e., where the edges in the graph are not associated with a direction.

The graph 702 can be represented in any of a variety of ways. For example, the graph 702 can be represented as a two-dimensional array of numerical values with a number of rows and columns equal to the number of nodes in the graph. The component of the array at position (i, j) can have value 1 if the graph includes an edge pointing from node i to node j, and value 0 otherwise. In implementations where the graphing system 712 determines a weight value for each edge in the graph 702, the weight values can be similarly represented as a two-dimensional array of numerical values. More specifically, if the graph includes an edge connecting node i to node j, the component of the array at position (i, j) can have a value given by the corresponding edge weight, and otherwise the component of the array at position (i, j) can have value 0.

An architecture mapping system 720 can process the synaptic connectivity graph 702 to determine the architecture of the brain emulation neural network 704 (or a brain emulation subnetwork of a neural network). For example, the architecture mapping system 720 can map each node in the graph 702 to: (i) an artificial neuron, (ii) a neural network layer, or (iii) a group of neural network layers, in the architecture of the brain emulation neural network 704. The architecture mapping system 720 can further map each edge of the graph 702 to a connection in the brain emulation neural network 704, e.g., such that a first artificial neuron that is connected to a second artificial neuron is configured to provide its output to the second artificial neuron. In some implementations, the architecture mapping system 720 can apply one or more transformation operations to the graph 702 before mapping the nodes and edges of the graph 702 to corresponding components in the architecture of the brain emulation neural network 704, as will be described in more detail below. An example architecture mapping system is described in more detail below with reference to FIG. 8.

The brain emulation neural network 704 can be configured to process remote sensing data, captured by one or more sensors, that characterizes an environment, and to generate a network output that represents a prediction about the environment.

The brain emulation neural network 704 can be provided to a training system 714 that trains the brain emulation neural network using machine learning techniques, i.e., generates an update to the respective values of one or more parameters of the brain emulation neural network.

In some implementations, the training system 714 is a supervised training system that is configured to train the brain emulation neural network 704 using a set of training data. The training data can include multiple training examples, where each training example specifies: (i) a training input that includes or is determined from a set of remote sensing data characterizing a respective environment, and (ii) a corresponding target output that should be generated by the brain emulation neural network 704 by processing the training input. In one example, the direct training system 714 can train the brain emulation neural network 704 over multiple training iterations using a gradient descent optimization technique, e.g., stochastic gradient descent. In this example, at each training iteration, the direct training system 714 can sample a “batch” (set) of one or more training examples from the training data, and process the training inputs specified by the training examples to generate corresponding network outputs. The direct training system 714 can evaluate an objective function that measures a similarity between: (i) the target outputs specified by the training examples, and (ii) the network outputs generated by the brain emulation neural network, e.g., a cross-entropy or squared-error objective function. The direct training system 714 can determine gradients of the objective function, e.g., using backpropagation techniques, and update the parameter values of the brain emulation neural network 704 using the gradients, e.g., using any appropriate gradient descent optimization algorithm, e.g., RMSprop or Adam.

In some other implementations, the training system 714 is a distillation training system that is configured to use the brain emulation neural network 704 to facilitate training of a “student” neural network having a less complex architecture than the brain emulation neural network 704. The complexity of a neural network architecture can be measured, e.g., by the number of parameters required to specify the operations performed by the neural network. The training system 714 can train the student neural network to match the outputs generated by the brain emulation neural network. After training, the student neural network can inherit the capacity of the brain emulation neural network 704 to effectively solve certain tasks, while consuming fewer computational resources (e.g., memory and computing power) than the brain emulation neural network 704. Typically, the training system 714 does not update the parameters of the brain emulation neural network 704 while training the student neural network. That is, in these implementations, the training system 714 is configured to train the student neural network instead of the brain emulation neural network 704.

As a particular example, the training system 714 can be a distillation training system that trains the student neural network in an adversarial manner. For example, the training system 714 can include a discriminator neural network that is configured to process network outputs that were generated either by the brain emulation neural network 704 or the student neural network, and to generate a prediction of whether the network outputs where generated by the brain emulation neural network 704 or the student neural network. The training system can then determine an update to the parameters of the student neural network in order to increase an error in the prediction of the discriminator neural network; that is, the goal of the student neural network is to generate network outputs that resemble network outputs generated by the brain emulation neural network 702 so that the discriminator neural network predicts that they were generated by the brain emulation neural network 704.

In some implementations, the brain emulation neural network 704 is a subnetwork of a neural network that includes one or more other neural network layers, e.g., one or more other subnetworks.

For example, the brain emulation neural network 704 can be a subnetwork of a “reservoir computing” neural network. The reservoir computing neural network can include i) the brain emulation neural network, which includes untrained parameters, and ii) one or more other subnetworks that include trained parameters. For example, the reservoir computing neural network can be configured to process a network input using the brain emulation neural network 704 to generate an alternative representation of the network input, and process the alternative representation of the network input using a “prediction” subnetwork to generate a network output.

During training of the reservoir computing neural network, the parameter values of the one or more other subnetworks (e.g., the prediction subnetwork) are trained, but the parameter values of the brain emulation neural network 704 are static, i.e., are not trained. Instead of being trained, the parameter values of the brain emulation neural network 704 can be determined from the weight values of the edges of the synaptic connectivity graph, as will be described in more detail below. The reservoir computing neural network facilitates application of the brain emulation neural network to machine learning tasks by obviating the need to train the parameter values of the brain emulation neural network 704.

After the training system 714 has completed training the brain emulation neural network 704 (or a neural network that includes the brain emulation neural network as a subnetwork, or a student neural network trained using the brain emulation neural network), the brain emulation neural network 704 can be deployed by a deployment system 722. That is, the operations of the brain emulation neural network 704 can be implemented on a device or a system of devices for performing inference, i.e., receiving network inputs and processing the network inputs to generate network outputs. In some implementations, the brain emulation neural network 704 can be deployed onto a cloud system, i.e., a distributed computing system having multiple computing nodes, e.g., hundreds or thousands of computing nodes, in one or more locations. In some other implementations, the brain emulation neural network 704 can be deployed onto a user device.

FIG. 8 shows an example architecture mapping system 800. The architecture mapping system 800 is an example of a system implemented as computer programs on one or more computers in one or more locations in which the systems, components, and techniques described below are implemented.

The architecture mapping system 800 is configured to process a synaptic connectivity graph 801 (e.g., the synaptic connectivity graph 702 depicted in FIG. 7) to determine a corresponding neural network architecture 802 of a brain emulation neural network 816 (e.g., the brain emulation neural network 704 depicted in FIG. 7). The brain emulation neural network 816 can be configured to process remote sensing data captured by one or more sensors and characterizing an environment, and to generate a prediction about the environment.

The architecture mapping system 800 can determine the architecture 802 using one or more of: a transformation engine 804, a feature generation engine 806, a node classification engine 808, and a nucleus classification engine 818, which will each be described in more detail next.

The transformation engine 804 can be configured to apply one or more transformation operations to the synaptic connectivity graph 801 that alter the connectivity of the graph 801, i.e., by adding or removing edges from the graph. A few examples of transformation operations follow.

In one example, to apply a transformation operation to the graph 801, the transformation engine 804 can randomly sample a set of node pairs from the graph (i.e., where each node pair specifies a first node and a second node). For example, the transformation engine can sample a predefined number of node pairs in accordance with a uniform probability distribution over the set of possible node pairs. For each sampled node pair, the transformation engine 804 can modify the connectivity between the two nodes in the node pair with a predefined probability (e.g., 0.1%). In one example, the transformation engine 804 can connect the nodes by an edge (i.e., if they are not already connected by an edge) with the predefined probability. In another example, the transformation engine 804 can reverse the direction of any edge connecting the two nodes with the predefined probability. In another example, the transformation engine 804 can invert the connectivity between the two nodes with the predefined probability, i.e., by adding an edge between the nodes if they are not already connected, and by removing the edge between the nodes if they are already connected.

In another example, the transformation engine 804 can apply a convolutional filter to a representation of the graph 801 as a two-dimensional array of numerical values. As described above, the graph 801 can be represented as a two-dimensional array of numerical values where the component of the array at position (i, j) can have value 1 if the graph includes an edge pointing from node i to node j, and value 0 otherwise. The convolutional filter can have any appropriate kernel, e.g., a spherical kernel or a Gaussian kernel. After applying the convolutional filter, the transformation engine 804 can quantize the values in the array representing the graph, e.g., by rounding each value in the array to 0 or 1, to cause the array to unambiguously specify the connectivity of the graph. Applying a convolutional filter to the representation of the graph 801 can have the effect of regularizing the graph, e.g., by smoothing the values in the array representing the graph to reduce the likelihood of a component in the array having a different value than many of its neighbors.

In some cases, the graph 801 can include some inaccuracies in representing the biological connectivity in the biological brain. For example, the graph can include nodes that are not connected by an edge despite the corresponding neurons in the brain being connected by a synapse, or “spurious” edges that connect nodes in the graph despite the corresponding neurons in the brain not being connected by a synapse. Inaccuracies in the graph can result, e.g., from imaging artifacts or ambiguities in the synaptic resolution image of the brain that is processed to generate the graph. Regularizing the graph, e.g., by applying a convolutional filter to the representation of the graph, can increase the accuracy with which the graph represents the biological connectivity in the brain, e.g., by removing spurious edges.

The architecture mapping system 800 can use the feature generation engine 806 and the node classification engine 808 to determine predicted “types” 810 of the neuronal elements corresponding to the nodes in the graph 801. The type of a neuronal element can characterize any appropriate aspect of the neuronal element. In one example, the type of a neuronal element can characterize the function performed by the neuronal element in the brain, e.g., a visual function by processing visual data, an olfactory function by processing odor data, or a memory function by retaining information. After identifying the types of the neuronal elements corresponding to the nodes in the graph 801, the architecture mapping system 800 can identify a sub-graph 812 of the overall graph 801 based on the neuronal element types, and determine the neural network architecture 802 based on the sub-graph 812. The feature generation engine 806 and the node classification engine 808 are described in more detail next.

The feature generation engine 806 can be configured to process the graph 801 (potentially after it has been modified by the transformation engine 804) to generate one or more respective node features 814 corresponding to each node of the graph 801. The node features corresponding to a node can characterize the topology (i.e., connectivity) of the graph relative to the node. In one example, the feature generation engine 806 can generate a node degree feature for each node in the graph 801, where the node degree feature for a given node specifies the number of other nodes that are connected to the given node by an edge. In another example, the feature generation engine 806 can generate a path length feature for each node in the graph 801, where the path length feature for a node specifies the length of the longest path in the graph starting from the node. A path in the graph may refer to a sequence of nodes in the graph, such that each node in the path is connected by an edge to the next node in the path. The length of a path in the graph may refer to the number of nodes in the path. In another example, the feature generation engine 806 can generate a neighborhood size feature for each node in the graph 801, where the neighborhood size feature for a given node specifies the number of other nodes that are connected to the node by a path of length at most N. In this example, N can be a positive integer value. In another example, the feature generation engine 806 can generate an information flow feature for each node in the graph 801. The information flow feature for a given node can specify the fraction of the edges connected to the given node that are outgoing edges, i.e., the fraction of edges connected to the given node that point from the given node to a different node.

In some implementations, the feature generation engine 806 can generate one or more node features that do not directly characterize the topology of the graph relative to the nodes. In one example, the feature generation engine 806 can generate a spatial position feature for each node in the graph 801, where the spatial position feature for a given node specifies the spatial position in the brain of the neuronal element corresponding to the node, e.g., in a Cartesian coordinate system of the synaptic resolution image of the brain. In another example, the feature generation engine 806 can generate a feature for each node in the graph 801 indicating whether the corresponding neuronal element is excitatory or inhibitory. In another example, the feature generation engine 806 can generate a feature for each node in the graph 801 that identifies the neuropil region associated with the neuronal element corresponding to the node.

In some cases, the feature generation engine 806 can use weights associated with the edges in the graph in determining the node features 814. As described above, a weight value for an edge connecting two nodes can be determined, e.g., based on the area of any overlap between tolerance regions around the neuronal elements corresponding to the nodes. In one example, the feature generation engine 806 can determine the node degree feature for a given node as a sum of the weights corresponding to the edges that connect the given node to other nodes in the graph. In another example, the feature generation engine 806 can determine the path length feature for a given node as a sum of the edge weights along the longest path in the graph starting from the node.

The node classification engine 808 can be configured to process the node features 814 to identify a predicted neuronal element type 810 corresponding to certain nodes of the graph 801. In one example, the node classification engine 808 can process the node features 814 to identify a proper subset of the nodes in the graph 801 with the highest values of the path length feature. For example, the node classification engine 808 can identify the nodes with a path length feature value greater than the 90th percentile (or any other appropriate percentile) of the path length feature values of all the nodes in the graph. The node classification engine 808 can then associate the identified nodes having the highest values of the path length feature with the predicted neuronal element type of “primary sensory neuronal element.” In another example, the node classification engine 808 can process the node features 814 to identify a proper subset of the nodes in the graph 801 with the highest values of the information flow feature, i.e., indicating that many of the edges connected to the node are outgoing edges. The node classification engine 808 can then associate the identified nodes having the highest values of the information flow feature with the predicted neuronal element type of “sensory neuronal element.” In another example, the node classification engine 808 can process the node features 814 to identify a proper subset of the nodes in the graph 801 with the lowest values of the information flow feature, i.e., indicating that many of the edges connected to the node are incoming edges (i.e., edges that point towards the node). The node classification engine 808 can then associate the identified nodes having the lowest values of the information flow feature with the predicted neuronal element type of “associative neuronal element.”

The architecture mapping system 800 can identify a sub-graph 812 of the overall graph 801 based on the predicted neuronal element types 810 corresponding to the nodes of the graph 801. A “sub-graph” may refer to a graph specified by: (i) a proper subset of the nodes of the graph 801, and (ii) a proper subset of the edges of the graph 801. FIG. 9 provides an illustration of an example sub-graph of an overall graph. In one example, the architecture mapping system 800 can select: (i) each node in the graph 801 corresponding to particular neuronal element type, and (ii) each edge in the graph 801 that connects nodes in the graph corresponding to the particular neuronal element type, for inclusion in the sub-graph 812. The neuronal element type selected for inclusion in the sub-graph can be, e.g., visual neuronal elements, olfactory neuronal elements, memory neuronal elements, or any other appropriate type of neuronal element. In some cases, the architecture mapping system 800 can select multiple neuronal element types for inclusion in the sub-graph 812, e.g., both visual neuronal elements and olfactory neuronal elements.

The type of neuronal element selected for inclusion in the sub-graph 812 can be determined based on the task which the brain emulation neural network 816 will be configured to perform, e.g., based on the type of remote sensing data that the brain emulation neural network 816 will be configured to process. In one example, the brain emulation neural network 816 can be configured to perform an image processing task (i.e., to process remote sensing data that includes one or more images of an environment), and neuronal elements that are predicted to perform visual functions (i.e., by processing visual sensory data) can be selected for inclusion in the sub-graph 812. In another example, the brain emulation neural network 816 can be configured to perform an odor processing task (i.e., to process remote sensing data that includes olfactory data of an environment), and neuronal elements that are predicted to perform odor processing functions (i.e., by processing olfactory sensory inputs) can be selected for inclusion in the sub-graph 812. In another example, the brain emulation neural network 816 can be configured to perform an audio processing task (i.e., to process remote sensing data that includes audio data of an environment), and neuronal elements that are predicted to perform audio processing (i.e., by processing audio sensory data) can be selected for inclusion in the sub-graph 812.

If the edges of the graph 801 are associated with weight values (as described above), then each edge of the sub-graph 812 can be associated with the weight value of the corresponding edge in the graph 801. The sub-graph 812 can be represented, e.g., as a two-dimensional array of numerical values, as described with reference to the graph 801.

Determining the architecture 802 of the brain emulation neural network 816 based on the sub-graph 812 rather than the overall graph 801 can result in the architecture 802 having a reduced complexity, e.g., because the sub-graph 812 has fewer nodes, fewer edges, or both than the graph 801. Reducing the complexity of the architecture 802 can reduce consumption of computational resources (e.g., memory and computing power) by the brain emulation neural network 816, e.g., enabling the brain emulation neural network 816 to be deployed in resource-constrained environments, e.g., mobile devices. Reducing the complexity of the architecture 802 can also facilitate training of the brain emulation neural network 816, e.g., by reducing the amount of training data required to train the brain emulation neural network 816 to achieve an threshold level of performance (e.g., prediction accuracy).

In some cases, the architecture mapping system 800 can further reduce the complexity of the architecture 802 using a nucleus classification engine 818. In particular, the architecture mapping system 800 can process the sub-graph 812 using the nucleus classification engine 818 prior to determining the architecture 802. The nucleus classification engine 818 can be configured to process a representation of the sub-graph 812 as a two-dimensional array of numerical values (as described above) to identify one or more “clusters” in the array.

A cluster in the array representing the sub-graph 812 may refer to a contiguous region of the array such that at least a threshold fraction of the components in the region have a value indicating that an edge exists between the pair of nodes corresponding to the component. In one example, the component of the array in position (i, j) can have value 1 if an edge exists from node i to node j, and value 0 otherwise. In this example, the nucleus classification engine 818 can identify contiguous regions of the array such that at least a threshold fraction of the components in the region have the value 1. The nucleus classification engine 818 can identify clusters in the array representing the sub-graph 812 by processing the array using a blob detection algorithm, e.g., by convolving the array with a Gaussian kernel and then applying the Laplacian operator to the array. After applying the Laplacian operator, the nucleus classification engine 818 can identify each component of the array having a value that satisfies a predefined threshold as being included in a cluster.

Each of the clusters identified in the array representing the sub-graph 812 can correspond to edges connecting a “nucleus” (i.e., group) of related neuronal elements in brain, e.g., a thalamic nucleus, a vestibular nucleus, a dentate nucleus, or a fastigial nucleus. After the nucleus classification engine 818 identifies the clusters in the array representing the sub-graph 812, the architecture mapping system 800 can select one or more of the clusters for inclusion in the sub-graph 812. The architecture mapping system 800 can select the clusters for inclusion in the sub-graph 812 based on respective features associated with each of the clusters. The features associated with a cluster can include, e.g., the number of edges (i.e., components of the array) in the cluster, the average of the node features corresponding to each node that is connected by an edge in the cluster, or both. In one example, the architecture mapping system 800 can select a predefined number of largest clusters (i.e., that include the greatest number of edges) for inclusion in the sub-graph 812.

The architecture mapping system 800 can reduce the sub-graph 812 by removing any edge in the sub-graph 812 that is not included in one of the selected clusters, and then map the reduced sub-graph 812 to a corresponding neural network architecture, as will be described in more detail below. Reducing the sub-graph 812 by restricting it to include only edges that are included in selected clusters can further reduce the complexity of the architecture 802, thereby reducing computational resource consumption by the brain emulation neural network 816 and facilitating training of the brain emulation neural network 816.

The architecture mapping system 800 can determine the architecture 802 of the brain emulation neural network 816 from the sub-graph 812 in any of a variety of ways. For example, the architecture mapping system 800 can map each node in the sub-graph 812 to a corresponding: (i) artificial neuron, (ii) artificial neural network layer, or (iii) group of artificial neural network layers in the architecture 802, as will be described in more detail next.

In one example, the neural network architecture 802 can include: (i) a respective artificial neuron corresponding to each node in the sub-graph 812, and (ii) a respective connection corresponding to each edge in the sub-graph 812. In this example, the sub-graph 812 can be a directed graph, and an edge that points from a first node to a second node in the sub-graph 812 can specify a connection pointing from a corresponding first artificial neuron to a corresponding second artificial neuron in the architecture 802. The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the sub-graph. An artificial neuron may refer to a component of the architecture 802 that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b as:

$$b = σ ( {\sum }_{i = 1}^{n} {w}_{i} \cdot {a}_{i} ) \qquad ( 1 )$$

where σ(⋅) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the sub-graph 812 can be an undirected graph, and the architecture mapping system 800 can map an edge that connects a first node to a second node in the sub-graph 812 to two connections between a corresponding first artificial neuron and a corresponding second artificial neuron in the architecture. In particular, the architecture mapping system 800 can map the edge to: (i) a first connection pointing from the first artificial neuron to the second artificial neuron, and (ii) a second connection pointing from the second artificial neuron to the first artificial neuron.

In another example, the sub-graph 812 can be an undirected graph, and the architecture mapping system can map an edge that connects a first node to a second node in the sub-graph 812 to one connection between a corresponding first artificial neuron and a corresponding second artificial neuron in the architecture. The architecture mapping system 800 can determine the direction of the connection between the first artificial neuron and the second artificial neuron, e.g., by randomly sampling the direction in accordance with a probability distribution over the set of two possible directions.

In some cases, the edges in the sub-graph 812 is not be associated with weight values, and the weight values corresponding to the connections in the architecture 802 can be determined randomly. For example, the weight value corresponding to each connection in the architecture 802 can be randomly sampled from a predetermined probability distribution, e.g., a standard Normal (N(0,1)) probability distribution.

In another example, the neural network architecture 802 can include: (i) a respective artificial neural network layer corresponding to each node in the sub-graph 812, and (ii) a respective connection corresponding to each edge in the sub-graph 812. In this example, a connection pointing from a first layer to a second layer can indicate that the output of the first layer should be provided as an input to the second layer. An artificial neural network layer may refer to a collection of artificial neurons, and the inputs to a layer and the output generated by the layer can be represented as ordered collections of numerical values (e.g., tensors of numerical values). In one example, the architecture 802 can include a respective convolutional neural network layer corresponding to each node in the sub-graph 812, and each given convolutional layer can generate an output d as:

$$d = σ ( {h}_{θ} ( {\sum }_{i = 1}^{n} {w}_{i} \cdot {c}_{i} ) ) \qquad ( 2 )$$

where each cᵢ (i=1, . . . , n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each edge can be specified by the weight value associated with the corresponding edge in the sub-graph), h_{θ}(⋅) represents the operation of applying one or more convolutional kernels to an input to generate a corresponding output, and if σ(⋅) is a non-linear activation function that is applied element-wise to each component of its input. In this example, each convolutional kernel can be represented as an array of numerical values, e.g., where each component of the array is randomly sampled from a predetermined probability distribution, e.g., a standard Normal probability distribution.

In another example, the architecture mapping system 800 can determine that the neural network architecture includes: (i) a respective group of artificial neural network layers corresponding to each node in the sub-graph 812, and (ii) a respective connection corresponding to each edge in the sub-graph 812. The layers in a group of artificial neural network layers corresponding to a node in the sub-graph 812 can be connected, e.g., as a linear sequence of layers, or in any other appropriate manner.

Various operations performed by the described architecture mapping system 800 are optional or can be implemented in a different order. For example, the architecture mapping system 800 can refrain from applying transformation operations to the graph 801 using the transformation engine 804, and refrain from extracting a sub-graph 812 from the graph 801 using the feature generation engine 806, the node classification engine 808, and the nucleus classification engine 818. In this example, the architecture mapping system 800 can directly map the graph 801 to the neural network architecture 802, e.g., by mapping each node in the graph to an artificial neuron and mapping each edge in the graph to a connection in the architecture, as described above.

FIG. 9 illustrates an example graph 900 and an example sub-graph 902. Each node in the graph 900 is represented by a circle (e.g., 904 and 906), and each edge in the graph 900 is represented by a line (e.g., 908 and 910). In this illustration, the graph 900 can be considered a simplified representation of a synaptic connectivity graph (an actual synaptic connectivity graph can have far more nodes and edges than are depicted in FIG. 9). A sub-graph 902 can be identified in the graph 900, where the sub-graph 902 includes a proper subset of the nodes and edges of the graph 900. In this example, the nodes included in the sub-graph 902 are hatched (e.g., 906) and the edges included in sub-graph 902 are dashed (e.g., 910). The nodes included in the sub-graph 902 can correspond to neuronal elements of a particular type, e.g., neuronal elements having a particular function, e.g., olfactory neuronal elements, visual neuronal elements, or memory neuronal elements. The architecture of the brain emulation neural network can be specified by the structure of the entire graph 900, or by the structure of a sub-graph 902, as described above.

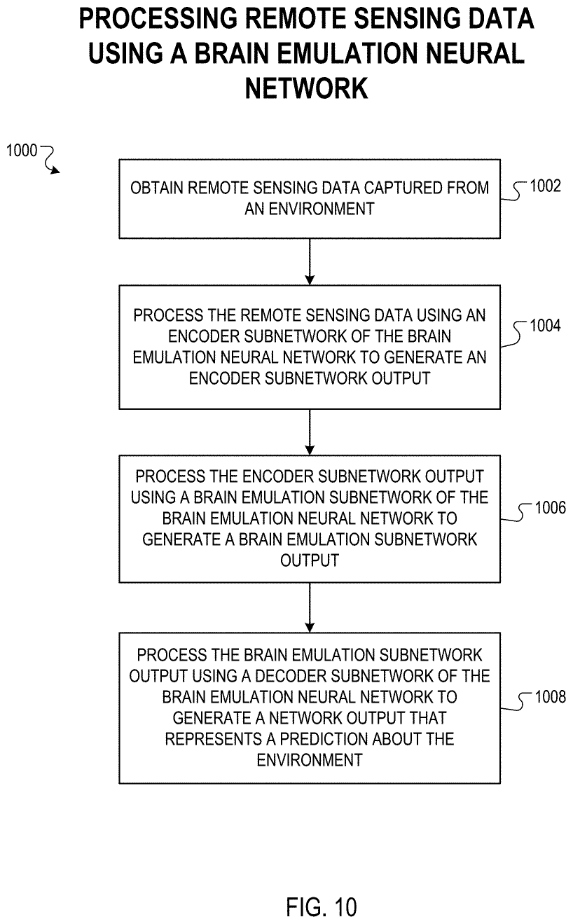

FIG. 10 is a flow diagram of an example process 1000 for processing remote sensing data using a brain emulation neural network. For convenience, the process 1000 will be described as being performed by a system of one or more computers located in one or more locations. For example, a neural network computing system, e.g., the neural network computing system 100 depicted in FIG. 1B, appropriately programmed in accordance with this specification, can perform the process 1000.

The system obtains remote sensing data captured from an environment (step 1002). For example, the environment can include multiple agricultural plots, and the remote sensing data can include an aerial image of the agricultural plots.

The system can then process the remote sensing data using the brain emulation neural network to generate a network output that represents a prediction about the environment. For example, the brain emulation neural network can be a segmentation neural network that is configured to generate a segmentation of the remote sensing data. As a particular example, the brain emulation neural network can process the aerial image of the agricultural plots to generate a network output that defines segmentation of the aerial image into multiple categories that includes at least one category corresponding to the agricultural plots. The operations of the brain emulation neural network are described in more detail below with reference to steps 1004, 1006, and 1008.

The system processes the remote sensing data using an encoder subnetwork of the brain emulation neural network to generate an encoder subnetwork output (step 1004). The encoder subnetwork can include one or more non-biological neural network layers.

The system processes the encoder subnetwork output using a brain emulation subnetwork of the brain emulation neural network to generate a brain emulation subnetwork output (step 1006). The brain emulation subnetwork can have a brain emulation neural network architecture that includes multiple brain emulation parameters that, when initialized, represent biological connectivity between a set of biological neuronal elements in a brain of a biological organism.

The system processes the brain emulation subnetwork output using a decoder subnetwork of the brain emulation neural network to generate the network output that represents a prediction about the environment (step 1008). The decoder subnetwork can include one or more non-biological neural network layers.

After generating the network output, the system can further process the network output to determine the prediction about the environment. For example, the system can identify at least one of the multiple agricultural plots in the aerial image from the segmentation of the aerial image.

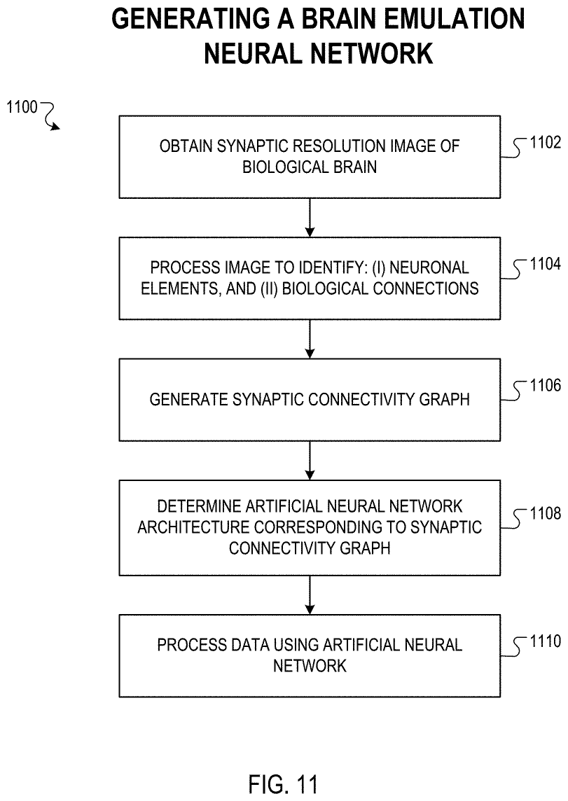

FIG. 11 is a flow diagram of an example process 1100 for generating a brain emulation neural network. For convenience, the process 1100 will be described as being performed by a system of one or more computers located in one or more locations.

The system obtains a synaptic resolution image of at least a portion of a brain of a biological organism (1102).

The system processes the image to identify: (i) neuronal elements in the brain, and (ii) biological connections between the neuronal elements in the brain (1104).

The system generates data defining a graph representing biological connectivity between the neuronal elements in the brain (1106). The graph includes a set of nodes and a set of edges, where each edge connects a pair of nodes. The system identifies each neuronal element in the brain as a respective node in the graph, and each biological connection between a pair of neuronal elements in the brain as an edge between a corresponding pair of nodes in the graph.

The system determines an artificial neural network architecture corresponding to the graph representing the biological connectivity between the neuronal elements in the brain (1108).

The system processes a network input using an artificial neural network having the artificial neural network architecture to generate a network output (1110).

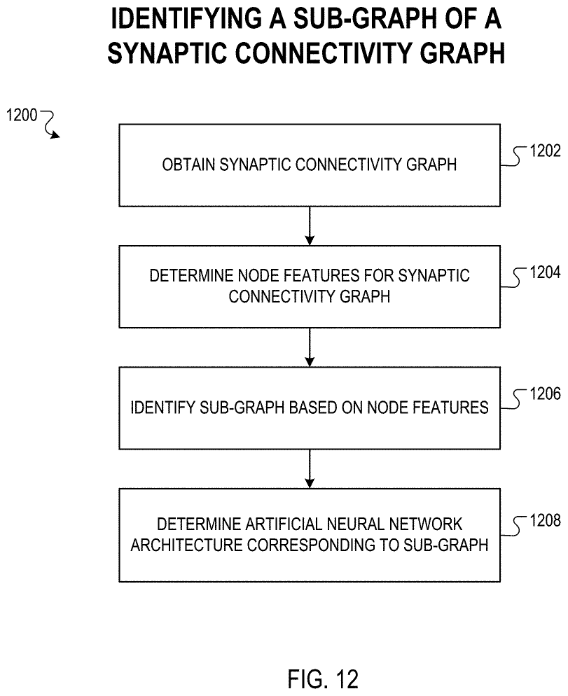

FIG. 12 is a flow diagram of an example process 1200 for determining an artificial neural network architecture corresponding to a sub-graph of a synaptic connectivity graph. For convenience, the process 1200 will be described as being performed by a system of one or more computers located in one or more locations. For example, an architecture mapping system, e.g., the architecture mapping system 800 of FIG. 8, appropriately programmed in accordance with this specification, can perform the process 1200.

The system obtains data defining a graph representing biological connectivity between neuronal elements in a brain of a biological organism (1202). The graph includes a set of nodes and edges, where each edge connects a pair of nodes. Each node corresponds to a respective neuronal element in the brain of the biological organism, and each edge connecting a pair of nodes in the graph corresponds to a biological connection between a pair of neuronal elements in the brain of the biological organism.

The system determines, for each node in the graph, a respective set of one or more node features characterizing a structure of the graph relative to the node (1204).

The system identifies a sub-graph of the graph (1206). In particular, the system selects a proper subset of the nodes in the graph for inclusion in the sub-graph based on the node features of the nodes in the graph.

The system determines an artificial neural network architecture corresponding to the sub-graph of the graph (1208).

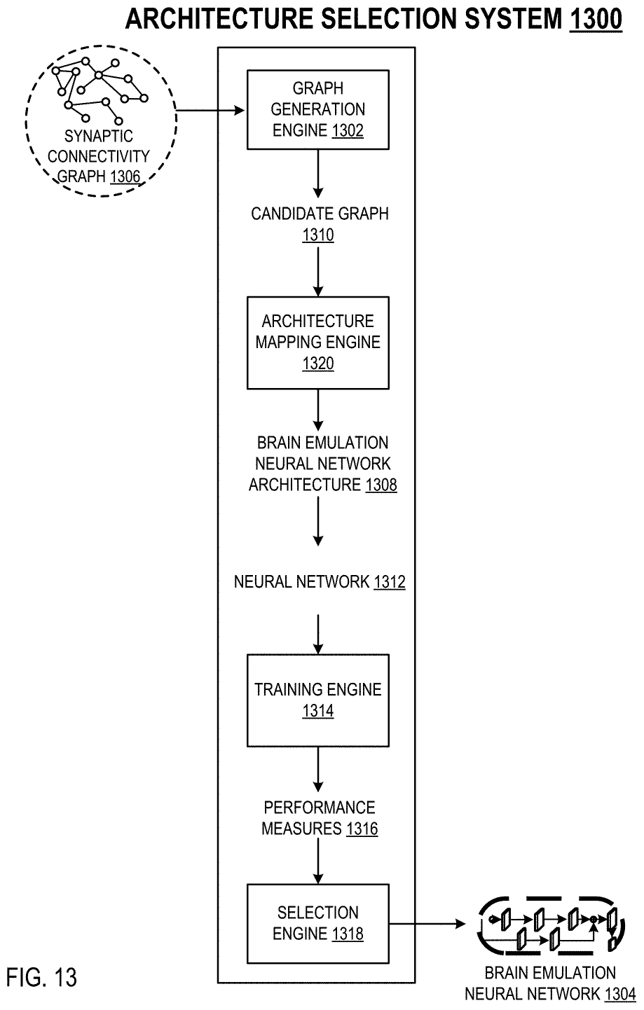

FIG. 13 is an example architecture selection system 1300. The architecture selection system 1300 is an example of a system implemented as computer programs on one or more computers in one or more locations in which the systems, components, and techniques described below are implemented.

The system 1300 is configured to search a space of possible neural network architectures to identify the neural network architecture of a brain emulation neural network 1304 to be included in a neural network (e.g., the network 102 in FIG. 1B or the network 502 in FIG. 5). The neural network can be configured to process remote sensing data captured by one or more sensors and characterizing an environment, and generate a prediction about the environment. In some implementations, the system 1300 can identify multiple brain emulation neural networks 1304 to be included in the neural network.

The system 1300 can seed the search through the space of possible neural network architectures using a synaptic connectivity graph 1306 representing biological connectivity in the brain of a biological organism. The synaptic connectivity graph 1306 may be derived directly from a synaptic resolution image of the brain of a biological organism, e.g., as described with reference to FIG. 6. In some cases, the synaptic connectivity graph 1306 may be a sub-graph of a larger graph derived from a synaptic resolution image of a brain, e.g., a sub-graph that includes neuronal elements of a particular type, e.g., neuronal elements that process sensory inputs that are of the same type as (or that are otherwise similar to) the remote sensing data that the neural network is configured to process.

The system 1300 includes a graph generation engine 1302, an architecture mapping engine 1320, a training engine 1314, and a selection engine 1318, each of which will be described in more detail next.

The graph generation engine 1302 is configured to process the synaptic connectivity graph 1306 to generate multiple “candidate” graphs 1310, where each candidate graph is defined by a set of nodes and a set of edges, such that each edge connects a pair of nodes. The graph generation engine 1302 may generate the candidate graphs 1310 from the synaptic connectivity graph 1306 using any of a variety of techniques. A few examples follow.

In one example, the graph generation engine 1302 may generate a candidate graph 1310 at each of multiple iterations by processing the synaptic connectivity graph 1306 in accordance with current values of a set of graph generation parameters. The current values of the graph generation parameters may specify (transformation) operations to be applied to an adjacency matrix representing the synaptic connectivity graph 1306 to generate an adjacency matrix representing a candidate graph 1310. The operations to be applied to the adjacency matrix representing the synaptic connectivity graph may include, e.g., filtering operations, cropping operations, or both. The candidate graph 1310 may be defined by the result of applying the operations specified by the current values of the graph generation parameters to the adjacency matrix representing the synaptic connectivity graph 1306.

The graph generation engine 1302 may apply a filtering operation to the adjacency matrix representing the synaptic connectivity graph 1306, e.g., by convolving a filtering kernel with the adjacency matrix representing the synaptic connectivity graph. The filtering kernel may be defined by a two-dimensional matrix, where the components of the matrix are specified by the graph generation parameters. Applying a filtering operation to the adjacency matrix representing the synaptic connectivity graph 1306 may have the effect of adding edges to the synaptic connectivity graph 1306, removing edges from the synaptic connectivity graph 1306, or both.

The graph generation engine 1302 may apply a cropping operation to the adjacency matrix representing the synaptic connectivity graph 1306, where the cropping operation replaces the adjacency matrix representing the synaptic connectivity graph 1306 with an adjacency matrix representing a sub-graph of the synaptic connectivity graph 1306. Generally, a “sub-graph” may refer to a graph specified by: (i) a proper subset of the nodes of the graph 1306, and (ii) a proper subset of the edges of the graph 1306. The cropping operation may specify a sub-graph of synaptic connectivity graph 1306, e.g., by specifying a proper subset of the rows and a proper subset of the columns of the adjacency matrix representing the synaptic connectivity graph 1306 that define a sub-matrix of the adjacency matrix. The sub-graph may include: (i) each edge specified by the sub-matrix, and (ii) each node that is connected by an edge specified by the sub-matrix.

At each iteration, the system 1300 determines a performance measure 1316 corresponding to the candidate graph 1310 generated at the iteration, and the system 1300 updates the current values of the graph generation parameters to encourage the generation of candidate graphs 1310 with higher performance measures 1316. The performance measure 1316 for a candidate graph 1310 characterizes the performance of a neural network that includes a brain emulation neural network having an architecture specified by the candidate graph 1310 at performing a machine learning task. Determining performance measures 1316 for candidate graphs 1310 will be described in more detail below. The system 1300 may use any appropriate optimization technique to update the current values of the graph generation parameters, e.g., a “black-box” optimization technique that does not rely on computing gradients of the operations performed by the graph generation engine 1302. Examples of black-box optimization techniques which may be implemented by the optimization engine are described with reference to: Golovin, D., Solnik, B., Moitra, S., Kochanski, G., Karro, J., & Sculley, D.: “Google vizier: A service for black-box optimization,” In Proceedings of the 23rd ACM SIGKDD International Conference on Knowledge Discovery and Data Mining, pp. 1487-1495 (2017). Prior to the first iteration, the values of the graph generation parameters may be set to default values or randomly initialized.

In another example, the graph generation engine 1302 may generate the candidate graphs 1310 by “evolving” a population (i.e., a set) of graphs derived from the synaptic connectivity graph 1306 over multiple iterations. The graph generation engine 1302 may initialize the population of graphs, e.g., by “mutating” multiple copies of the synaptic connectivity graph 1306. Mutating a graph refers to making a random change to the graph, e.g., by randomly adding or removing edges or nodes from the graph. After initializing the population of graphs, the graph generation engine 1302 may generate a candidate graph at each of multiple iterations by, at each iteration, selecting a graph from the population of graphs derived from the synaptic connectivity graph and mutating the selected graph to generate a candidate graph 1310. The graph generation engine 1302 may determine a performance measure 1316 for the candidate graph 1310, and use the performance measure to determine whether the candidate graph 1310 is added to the current population of graphs. In some implementations, each edge of the synaptic connectivity graph may be associated with a weight value that is determined from the synaptic resolution image of the brain, as described above. Each candidate graph may inherit the weight values associated with the edges of the synaptic connectivity graph. For example, each edge in the candidate graph that corresponds to an edge in the synaptic connectivity graph may be associated with the same weight value as the corresponding edge in the synaptic connectivity graph. Edges in the candidate graph that do not correspond to edges in the synaptic connectivity graph may be associated with default or randomly initialized weight values.

In another example, the graph generation engine 1302 can generate each candidate graph 1310 as a sub-graph of the synaptic connectivity graph 1306. For example, the graph generation engine 1302 can randomly select sub-graphs, e.g., by randomly selecting a proper subset of the rows and a proper subset of the columns of the adjacency matrix representing the synaptic connectivity graph 1306 that define a sub-matrix of the adjacency matrix. The sub-graph may include: (i) each edge specified by the sub-matrix, and (ii) each node that is connected by an edge specified by the sub-matrix.

The architecture mapping engine 1320 processes each candidate graph 1310 to generate a corresponding brain emulation neural network architecture 1308. The architecture mapping engine 1320 may use the candidate graph 1310 derived from the synaptic connectivity graph 1306 to specify the brain emulation neural network architecture 1308 in any of a variety of ways. For example, the architecture mapping engine 1320 may map each node in the candidate graph 1310 to a corresponding: (i) artificial neuron, (ii) artificial neural network layer, or (iii) group of artificial neural network layers in the brain emulation neural network architecture 1308, as will be described in more detail next.

In one example, the brain emulation neural network architecture 1308 can include: (i) a respective artificial neuron corresponding to each node in the candidate graph 1310, and (ii) a respective connection corresponding to each edge in the candidate graph 1310. In this example, the graph can be a directed graph, and an edge that points from a first node to a second node in the graph can specify a connection pointing from a corresponding first artificial neuron to a corresponding second artificial neuron in the architecture. The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the graph.

An artificial neuron can refer to a component of the architecture that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b by executing equation (1) above.

In another example, the candidate graph 1310 can be an undirected graph, and the architecture mapping engine 1320 can map an edge that connects a first node to a second node in the graph to two connections between a corresponding first artificial neuron and a corresponding second artificial neuron in the architecture. In particular, the architecture mapping engine 1320 can map the edge to: (i) a first connection pointing from the first artificial neuron to the second artificial neuron, and (ii) a second connection pointing from the second artificial neuron to the first artificial neuron.

In another example, the candidate graph 1310 can be an undirected graph, and the architecture mapping engine 1320 can map an edge that connects a first node to a second node in the graph to one connection between a corresponding first artificial neuron and a corresponding second artificial neuron in the architecture. The architecture mapping engine 1320 can determine the direction of the connection between the first artificial neuron and the second artificial neuron, e.g., by randomly sampling the direction in accordance with a probability distribution over the set of two possible directions.

In some cases, the edges in the candidate graph are not associated with weight values, and the weight values corresponding to the connections in the architecture can be determined randomly. For example, the weight value corresponding to each connection in the architecture can be randomly sampled from a predetermined probability distribution, e.g., a standard Normal (N(0,1)) probability distribution.

In another example, the brain emulation neural network architecture 1308 can include: (i) a respective artificial neural network layer corresponding to each node in the candidate graph, and (ii) a respective connection corresponding to each edge in the candidate graph. In this example, a connection pointing from a first layer to a second layer can indicate that the output of the first layer should be provided as an input to the second layer. An artificial neural network layer can refer to a collection of artificial neurons, and the inputs to a layer and the output generated by the layer can be represented as ordered collections of numerical values (e.g., tensors of numerical values). In one example, the architecture can include a respective convolutional neural network layer corresponding to each node in the graph, and each given convolutional layer can generate an output d by executing equation (2) above. In this example, each convolutional kernel can be represented as an array of numerical values, e.g., where each component of the array is randomly sampled from a predetermined probability distribution, e.g., a standard Normal probability distribution.

In another example, the architecture mapping engine 1320 can determine that the brain emulation neural network architecture includes: (i) a respective group of artificial neural network layers corresponding to each node in the graph, and (ii) a respective connection corresponding to each edge in the graph. The layers in a group of artificial neural network layers corresponding to a node in the graph can be connected, e.g., as a linear sequence of layers, or in any other appropriate manner.

The architecture of a brain emulation sub-network can directly represent biological connectivity in a region of the brain of the biological organism. More specifically, the system can map the nodes of the candidate graph (which each represent, e.g., a biological neuronal element in the brain) onto corresponding artificial neurons in the brain emulation sub-network. The system can also map the edges of the candidate graph (which each represent, e.g., a biological connection between a pair of neuronal elements in the brain) onto connections between corresponding pairs of artificial neurons in the brain emulation sub-network. The system can map the respective weight associated with each edge in the candidate graph to a corresponding weight (i.e., parameter value) of a corresponding connection in the brain emulation sub-network. The weight corresponding to an edge (representing, e.g., a biological connection in the brain) between a pair of nodes in the candidate graph (representing a pair of biological neuronal elements in the brain) can represent a proximity of the pair of biological neuronal elements in the brain, as described above.

For each brain emulation neural network architecture 1308, the training engine 1314 instantiates a neural network 1312, e.g., the neural network 102 described with reference to FIG. 1B, or the neural network 502 described with reference to FIG. 5. The neural network 1312 can include a brain emulation sub-network that has the brain emulation neural network architecture 1308 and acts as the reservoir. In particular, a neural network can include multiple brain emulation sub-networks. Accordingly, the training engine 1314 can instantiate multiple neural networks 1312 having any appropriate configuration of multiple brain emulation sub-networks. In one example, the training engine 1314 can instantiate a neural network having multiple copies of the same brain emulation sub-network. In another example, the training engine 1314 can instantiate a neural network having multiple different brain emulation sub-networks, e.g., multiple sub-networks that are each specified by a different candidate graph 1310. The training engine 1314 can instantiate any appropriate number and configuration of the neural networks, including any appropriate number and configuration of brain emulation sub-networks, and evaluate each neural network at the same machine learning task, as will be described in more detail next.

Each neural network 1312 is configured to perform a machine learning task, e.g., by processing a network input to generate a corresponding network output that defines a prediction characterizing the network input. The machine learning task can be any appropriate machine learning task, e.g., a classification task, a regression task, a segmentation task, an agent control task, or a combination thereof. The training engine 1314 is configured to train each neural network 1312 over multiple training iterations.

The training engine 1314 determines a respective performance measure 1316 of each neural network 1312 on the machine learning task. For example, the training engine 1314 can train the neural network 1312 on a set of training data over a sequence of training iterations, e.g., using the training engine 516 described with reference to FIG. 5. The training engine 1314 can then evaluate the performance of the neural network 1312 on a set of validation data, e.g., that includes a set of training examples that are part of the training data used to train the neural network 1312. The training engine 1314 can evaluate the performance of the neural network 1312 on the set of validation data, e.g., by computing an average error (e.g., cross-entropy error or squared-error) in network outputs generated by the neural network for the validation data.

The selection engine 1318 uses the performance measures 1316 to generate the output brain emulation neural network 1304. In one example, the selection engine 1318 may generate a brain emulation neural network 1304 having the brain emulation neural network architecture 1308 associated with the best (e.g., highest) performance measure 1316. The output brain emulation neural network 1304 can then be included in, e.g., the neural network 102 described with reference to FIG. 1B.

As described above, the brain emulation neural network architecture can be specified by a synaptic connectivity graph that represents the structure of biological connections in the brain of the biological organism. The synaptic connectivity graph can be obtained from a synaptic resolution image of the brain of the biological organism, as is described in more detail above.

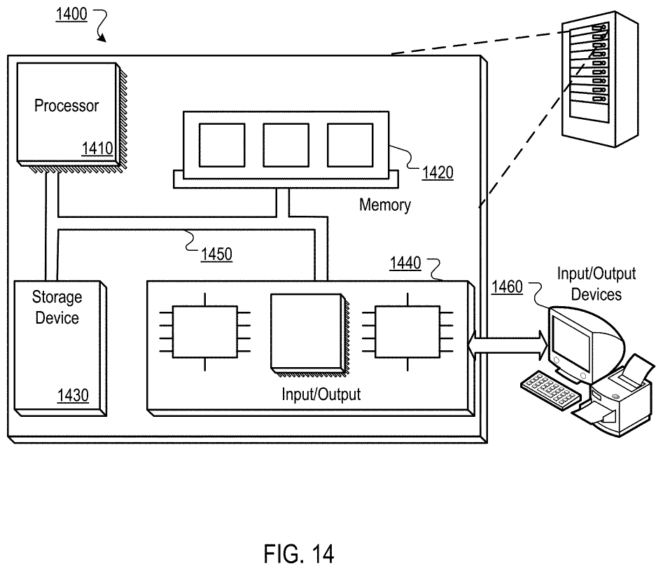

FIG. 14 is a block diagram of an example computer system 1400 that can be used to perform operations described previously. The system 1400 includes a processor 1410, a memory 1420, a storage device 1430, and an input/output device 1440. Each of the components 1410, 1420, 1430, and 1440 can be interconnected, for example, using a system bus 1450. The processor 1410 is capable of processing instructions for execution within the system 1400. In one implementation, the processor 1410 is a single-threaded processor. In another implementation, the processor 1410 is a multi-threaded processor. The processor 1410 is capable of processing instructions stored in the memory 1420 or on the storage device 1430.

The memory 1420 stores information within the system 1400. In one implementation, the memory 1420 is a computer-readable medium. In one implementation, the memory 1420 is a volatile memory unit. In another implementation, the memory 1420 is a non-volatile memory unit.

The storage device 1430 is capable of providing mass storage for the system 1400. In one implementation, the storage device 1430 is a computer-readable medium. In various different implementations, the storage device 1430 can include, for example, a hard disk device, an optical disk device, a storage device that is shared over a network by multiple computing devices (for example, a cloud storage device), or some other large capacity storage device.

The input/output device 1440 provides input/output operations for the system 1400. In one implementation, the input/output device 1440 can include one or more network interface devices, for example, an Ethernet card, a serial communication device, for example, and RS-232 port, and/or a wireless interface device, for example, and 802.11 card. In another implementation, the input/output device 1440 can include driver devices configured to receive input data and send output data to other input/output devices, for example, keyboard, printer and display devices 1460. Other implementations, however, can also be used, such as mobile computing devices, mobile communication devices, and set-top box television client devices.

Although an example processing system has been described in FIG. 14, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:

obtaining an aerial image of a plurality of agricultural plots;

processing the aerial image using a segmentation neural network to generate a network output that defines a segmentation of the aerial image into a plurality of categories including at least one agricultural plot category, comprising:
processing the aerial image using an encoder subnetwork of the segmentation neural network to generate an encoder subnetwork output;
processing the encoder subnetwork output using a brain emulation subnetwork of the segmentation neural network to generate a brain emulation subnetwork output, wherein the brain emulation subnetwork has a brain emulation neural network architecture that comprises a plurality of brain emulation parameters that, when initialized, represent biological connectivity between a plurality of biological neuronal elements in a brain of a biological organism; and
processing the brain emulation subnetwork output using a decoder subnetwork of the segmentation neural network to generate the network output that defines the segmentation of the aerial image; and identifying at least one of the plurality of agricultural plots in the aerial image from the segmentation of the aerial image.

Embodiment 2 is the method of embodiment 1, further comprising processing the network output to determine, for at least one of the plurality of agricultural plots, a boundary of the agricultural plot in the aerial image.

Embodiment 3 is the method of embodiment 2, wherein the aerial image has been captured by a camera, and wherein the method further comprises:

obtaining data identifying a location and pose of the camera when the aerial image was captured; and

determining, for each of the at least one agricultural plots and using the obtained data, real-world coordinates of the boundary of the agricultural plot.

Embodiment 4 is the method of any one of embodiments 1-3, wherein the plurality of categories of the segmentation of the aerial images comprises a plurality of categories corresponding to respective different types of crops grown in the agricultural plots.

Embodiment 5 is the method of any one of embodiments 1-4, wherein the segmentation neural network is configured to process a plurality of different modalities of remote sensing data, the plurality of modalities comprising one or more of: visible-light images, infrared images, radar images, x-ray images, ultrasound images, ultraviolet images, multispectral images, hyperspectral images, or LIDAR images.

Embodiment 6 is the method of any one of embodiments 1-5, wherein:

the aerial image is a first aerial image that represents a first portion of the plurality of agricultural plots, and

the method further comprises:
obtaining one or more second aerial images that represent respective different second portions of the plurality of agricultural plots;
processing each second aerial image using the segmentation neural network to generate a respective second network output that defines a segmentation of the second aerial image into the plurality of categories;
combining the respective segmentations of the first aerial image and the one or more second aerial images to generate a final segmentation that characterizes the first portion and each second portion of the plurality of agricultural plots.

Embodiment 7 is the method of embodiment 6, wherein combining the respective segmentations of the first aerial image and the second aerial image to generate a final segmentation comprises:

identifying, for each of the first aerial image and the one or more second aerial images, a respective location and pose of a camera that captured the image;

determining, from the locations and poses of the respective cameras that captured the first aerial image and the one or more second aerial images, a schema for combining the first aerial image and the one or more second aerial images to generate a combined image that depicts the first portion and each second portion of the plurality of agricultural plots; and

using the determined schema to combine the respective segmentations of the first aerial image and the one or more second aerial images to generate the final segmentation.

Embodiment 8 is the method of any one of embodiments 1-7, further comprising:

cropping the aerial image according to the segmentation to generate a cropped image, where the cropped image represents a strict subset of the plurality of categories of the segmentation; and

providing the cropped image to a machine learning model that is configured to process the cropped image and to generate a prediction about the plurality of agricultural plots.

Embodiment 9 is the method of embodiment 8, wherein the prediction about the plurality of agricultural plots comprises one or more of:

a predicted yield of the agricultural plots,

a predicted health of the agricultural plots,

a recommendation of a future time point at which to harvest the agricultural plots,

a recommended schedule for watering the agricultural plots, or

a recommended schedule for applying fertilizer to the agricultural plots.

Embodiment 10 is the method of any one of embodiments 1-9, wherein:

the segmentation neural network has been trained using a plurality of training aerial images of respective agricultural plots that each were captured at a different angle relative to the respective agricultural plots, and

the aerial image is not orthorectified before being processed by the segmentation neural network to generate the network output.

Embodiment 11 is the method of any one of embodiments 1-10, wherein the segmentation neural network has been trained using one or more auxiliary machine learning tasks that are different from segmenting the aerial image, the training comprising:

for each of the one or more auxiliary machine learning tasks:
processing a training aerial image using the segmentation neural network to generate an auxiliary output for the auxiliary machine learning task, and
updating a set of network parameters of the segmentation neural network according to an error in the auxiliary output.

Embodiment 12 is the method of embodiment 11, wherein the one or more auxiliary machine learning tasks comprise one or more of:

predicting a time of day at which the aerial image was captured,

predicting a time of year or date on which the aerial image was captured, or

predicting weather conditions when the aerial image was captured.

Embodiment 13 is the method of any one of embodiments 1-12, wherein the plurality of brain emulation parameters represent biological connectivity between a strict subset of the plurality of biological neuronal elements in the brain of the biological organism, wherein each biological neuronal element in the strict subset processes visual sensory inputs in the brain of the biological organism.

Embodiment 14 is the method of any one of embodiments 1-13, wherein the plurality of brain emulation parameters representing synaptic connectivity between the plurality of biological neurons in the brain of the biological organism are arranged in a two-dimensional weight matrix having a plurality of rows and a plurality of columns,

wherein each row and each column of the weight matrix corresponds to a respective biological neuron from the plurality of biological neurons, and

wherein each brain emulation parameter in the weight matrix corresponds to a respective pair of biological neurons in the brain of the biological organism, the pair comprising: (i) the biological neuron corresponding to a row of the brain emulation parameter in the weight matrix, and (ii) the biological neuron corresponding to a column of the brain emulation parameter in the weight matrix.

Embodiment 15 is the method of embodiment 14, wherein each brain emulation parameter of the weight matrix has a respective value that characterizes synaptic connectivity in the brain of the biological organism between the respective pair of biological neurons corresponding to the brain emulation parameter.

Embodiment 16 is the method of embodiment 15, wherein each brain emulation parameter of the weight matrix that corresponds to a respective pair of biological neurons that are not connected by a synaptic connection in the brain of the biological organism has value zero.

Embodiment 17 is the method of any one of embodiments 15 or 16, wherein each brain emulation parameter of the weight matrix that corresponds to a respective pair of biological neurons that are connected by a synaptic connection in the brain of the biological organism has a respective non-zero value characterizing an estimated strength of the synaptic connection.

Embodiment 18 is the method of any one of embodiments 1-17, wherein the brain emulation neural network architecture is determined from a synaptic connectivity graph that represents the synaptic connectivity between the biological neurons in the brain of the biological organism,

wherein the synaptic connectivity graph comprises a plurality of nodes and edges, each edge connects a pair of nodes, each node corresponds to a respective neuron in the brain of the biological organism, and each edge connecting a pair of nodes in the synaptic connectivity graph corresponds to a synaptic connection between a pair of biological neurons in the brain of the biological organism.

Embodiment 19 is a system comprising: one or more computers and one or more storage devices storing instructions that are operable, when executed by the one or more computers, to cause the one or more computers to perform the method of any one of embodiments 1 to 18.

Embodiment 20 is one or more non-transitory computer storage media encoded with a computer program, the program comprising instructions that are operable, when executed by data processing apparatus, to cause the data processing apparatus to perform the method of any one of embodiments 1 to 18.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method comprising:
obtaining an aerial image of a plurality of agricultural plots;
processing the aerial image using a segmentation neural network to generate a network output that defines a segmentation of the aerial image into a plurality of categories including at least one agricultural plot category, comprising:
processing the aerial image using an encoder subnetwork of the segmentation neural network to generate an encoder subnetwork output;
processing the encoder subnetwork output using a brain emulation subnetwork of the segmentation neural network to generate a brain emulation subnetwork output, wherein the brain emulation subnetwork has a brain emulation neural network architecture that comprises a plurality of brain emulation parameters that, when initialized, represent biological connectivity between a plurality of biological neuronal elements in a brain of a biological organism; and
processing the brain emulation subnetwork output using a decoder subnetwork of the segmentation neural network to generate the network output that defines the segmentation of the aerial image; and
identifying at least one of the plurality of agricultural plots in the aerial image from the segmentation of the aerial image.

2. The method of claim 1, further comprising processing the network output to determine, for at least one of the plurality of agricultural plots, a boundary of the agricultural plot in the aerial image.

3. The method of claim 2, wherein the aerial image has been captured by a camera, and wherein the method further comprises:
obtaining data identifying a location and pose of the camera when the aerial image was captured; and
determining, for each of the at least one agricultural plots and using the obtained data, real-world coordinates of the boundary of the agricultural plot.

4. The method of claim 1, wherein the plurality of categories of the segmentation of the aerial images comprises a plurality of categories corresponding to respective different types of crops grown in the agricultural plots.

5. The method of claim 1, wherein the segmentation neural network is configured to process a plurality of different modalities of remote sensing data, the plurality of modalities comprising one or more of: visible-light images, infrared images, radar images, x-ray images, ultrasound images, ultraviolet images, multispectral images, hyperspectral images, or LIDAR images.

6. The method of claim 1, wherein:
the aerial image is a first aerial image that represents a first portion of the plurality of agricultural plots, and
the method further comprises:
obtaining one or more second aerial images that represent respective different second portions of the plurality of agricultural plots;
processing each second aerial image using the segmentation neural network to generate a respective second network output that defines a segmentation of the second aerial image into the plurality of categories;
combining the respective segmentations of the first aerial image and the one or more second aerial images to generate a final segmentation that characterizes the first portion and each second portion of the plurality of agricultural plots.

7. The method of claim 6, wherein combining the respective segmentations of the first aerial image and the second aerial image to generate a final segmentation comprises:
identifying, for each of the first aerial image and the one or more second aerial images, a respective location and pose of a camera that captured the image;
determining, from the locations and poses of the respective cameras that captured the first aerial image and the one or more second aerial images, a schema for combining the first aerial image and the one or more second aerial images to generate a combined image that depicts the first portion and each second portion of the plurality of agricultural plots; and
using the determined schema to combine the respective segmentations of the first aerial image and the one or more second aerial images to generate the final segmentation.

8. The method of claim 1, further comprising:
cropping the aerial image according to the segmentation to generate a cropped image, where the cropped image represents a strict subset of the plurality of categories of the segmentation; and
providing the cropped image to a machine learning model that is configured to process the cropped image and to generate a prediction about the plurality of agricultural plots.

9. The method of claim 8, wherein the prediction about the plurality of agricultural plots comprises one or more of:
a predicted yield of the agricultural plots,
a predicted health of the agricultural plots,
a recommendation of a future time point at which to harvest the agricultural plots,
a recommended schedule for watering the agricultural plots, or
a recommended schedule for applying fertilizer to the agricultural plots.

10. The method of claim 1, wherein:
the segmentation neural network has been trained using a plurality of training aerial images of respective agricultural plots that each were captured at a different angle relative to the respective agricultural plots, and
the aerial image is not orthorectified before being processed by the segmentation neural network to generate the network output.

11. The method of claim 1, wherein the segmentation neural network has been trained using one or more auxiliary machine learning tasks that are different from segmenting the aerial image, the training comprising:
for each of the one or more auxiliary machine learning tasks:
processing a training aerial image using the segmentation neural network to generate an auxiliary output for the auxiliary machine learning task, and
updating a set of network parameters of the segmentation neural network according to an error in the auxiliary output.

12. The method of claim 11, wherein the one or more auxiliary machine learning tasks comprise one or more of:
predicting a time of day at which the aerial image was captured,
predicting a time of year or date on which the aerial image was captured, or
predicting weather conditions when the aerial image was captured.

13. The method of claim 1, wherein the plurality of brain emulation parameters represent biological connectivity between a strict subset of the plurality of biological neuronal elements in the brain of the biological organism, wherein each biological neuronal element in the strict subset processes visual sensory inputs in the brain of the biological organism.

14. The method of claim 1, wherein the plurality of brain emulation parameters representing synaptic connectivity between the plurality of biological neurons in the brain of the biological organism are arranged in a two-dimensional weight matrix having a plurality of rows and a plurality of columns,
wherein each row and each column of the weight matrix corresponds to a respective biological neuron from the plurality of biological neurons, and
wherein each brain emulation parameter in the weight matrix corresponds to a respective pair of biological neurons in the brain of the biological organism, the pair comprising: (i) the biological neuron corresponding to a row of the brain emulation parameter in the weight matrix, and (ii) the biological neuron corresponding to a column of the brain emulation parameter in the weight matrix.

15. The method of claim 14, wherein each brain emulation parameter of the weight matrix has a respective value that characterizes synaptic connectivity in the brain of the biological organism between the respective pair of biological neurons corresponding to the brain emulation parameter.

16. The method of claim 15, wherein each brain emulation parameter of the weight matrix that corresponds to a respective pair of biological neurons that are not connected by a synaptic connection in the brain of the biological organism has value zero.

17. The method of claim 15, wherein each brain emulation parameter of the weight matrix that corresponds to a respective pair of biological neurons that are connected by a synaptic connection in the brain of the biological organism has a respective non-zero value characterizing an estimated strength of the synaptic connection.

18. The method of claim 1, wherein the brain emulation neural network architecture is determined from a synaptic connectivity graph that represents the synaptic connectivity between the biological neurons in the brain of the biological organism,
wherein the synaptic connectivity graph comprises a plurality of nodes and edges, each edge connects a pair of nodes, each node corresponds to a respective neuron in the brain of the biological organism, and each edge connecting a pair of nodes in the synaptic connectivity graph corresponds to a synaptic connection between a pair of biological neurons in the brain of the biological organism.

19. A system comprising one or more computers and one or more storage devices storing instructions that are operable, when executed by the one or more computers, to cause the one or more computers to perform operations comprising:
obtaining an aerial image of a plurality of agricultural plots;
processing the aerial image using a segmentation neural network to generate a network output that defines a segmentation of the aerial image into a plurality of categories including at least one agricultural plot category, comprising:
processing the aerial image using an encoder subnetwork of the segmentation neural network to generate an encoder subnetwork output;
processing the encoder subnetwork output using a brain emulation subnetwork of the segmentation neural network to generate a brain emulation subnetwork output, wherein the brain emulation subnetwork has a brain emulation neural network architecture that comprises a plurality of brain emulation parameters that, when initialized, represent biological connectivity between a plurality of biological neuronal elements in a brain of a biological organism; and
processing the brain emulation subnetwork output using a decoder subnetwork of the segmentation neural network to generate the network output that defines the segmentation of the aerial image; and
identifying at least one of the plurality of agricultural plots in the aerial image from the segmentation of the aerial image.

20. One or more non-transitory computer storage media encoded with computer program instructions that when executed by a plurality of computers cause the plurality of computers to perform operations comprising:
obtaining an aerial image of a plurality of agricultural plots;
processing the aerial image using a segmentation neural network to generate a network output that defines a segmentation of the aerial image into a plurality of categories including at least one agricultural plot category, comprising:
processing the aerial image using an encoder subnetwork of the segmentation neural network to generate an encoder subnetwork output;
processing the encoder subnetwork output using a brain emulation subnetwork of the segmentation neural network to generate a brain emulation subnetwork output, wherein the brain emulation subnetwork has a brain emulation neural network architecture that comprises a plurality of brain emulation parameters that, when initialized, represent biological connectivity between a plurality of biological neuronal elements in a brain of a biological organism; and
processing the brain emulation subnetwork output using a decoder subnetwork of the segmentation neural network to generate the network output that defines the segmentation of the aerial image; and
identifying at least one of the plurality of agricultural plots in the aerial image from the segmentation of the aerial image.
